(19) United States
(12) Patent Application Publication
(10) Pub. No.: US 2026/0241593 A1
(43) Pub. Date: Aug. 20, 2026

(54) Food cutting device

(71) Applicant: Lingqiu Shen, Ningbo (CN)

(72) Inventor: Lingqiu Shen, Ningbo (CN)

(21) Appl. No.: 19/541,557

(22) Filed: Feb. 17, 2026

(30) Foreign Application Priority Data
Feb. 17, 2025 (CN) 202520247279.7
Feb. 17, 2025 (CN) 202520250156.9
Dec. 1, 2025 (CN) 202522553348.X
Dec. 1, 2025 (CN) 202522553350.7

(51) Int. Cl. B26D 1/143; A47J 43/25; B26D 1/00; B26D 3/26; B26D 5/00

(52) U.S. Cl. CPC B26D 1/143; A47J 43/255; B26D 3/26; B26D 5/00; B26D 2001/0033; B26D 2001/006

(57) ABSTRACT

The present disclosure provides a food cutting device including a housing comprising a first housing, a second housing, and an ejection component connected to the second housing; and a cutting assembly coupled to the first housing and disposed opposite the ejection component. The first housing is slidably attached to the second housing; the ejection component comprises a base portion connected to the second housing, and a plurality of ribs projecting away from the second housing and extending along a height direction; a top surface of the rib is higher than a upper surface of the base portion. The cutting blades are capable of ejecting food residues remaining on a housing while cleaning food residues remaining on cutting edges of a cutting component during a cutting process, thereby ensuring smooth subsequent cutting operations.

### RELATED APPLICATIONS

This application claims the benefit of priority to Chinese Patent Application Number 202520250156.9 filed on Feb. 17, 2025, Chinese Patent Application Number 202520247279.7 filed on Feb. 17, 2025, Chinese Patent Application Number 202522553350.7 filed on Dec. 1, 2025, and Chinese Patent Application Number 202522553348.X filed on Dec. 1, 2025, in the China National Intellectual Property Administration. The entire contents of the above-identified applications are hereby incorporated by reference.

### TECHNICAL FIELD

The present disclosure relates to the technical field of food processing equipment, and in particular, to a food cutting device.

### BACKGROUND

An important step in processing foods such as meat and vegetables involves cutting raw food into desired shapes. Currently, food cutting in food processing is primarily accomplished by manual cutting with food cutting devices.

In the prior art, Chinese Patent No. CN108858317B, titled “Food Cutting Device”, discloses a food cutting device including a housing and a cutting assembly. One side of the housing has a feeding port, and another side of the housing is configured to release cut food. The cutting assembly includes a cutting component and a handle for controlling a reciprocating movement of the cutting component. The cutting component includes a sliding member, a first cutting blade, and a plurality of second cutting blades. The sliding member is slidably attached to the housing. Both the first cutting blade and the second cutting blades are located on a side of the sliding member close to the feeding port and are detachably connected to the sliding member. The first cutting blade is parallel to a sliding direction of the sliding member, and the first cutting blade is not parallel to the second cutting blades. During the reciprocating movement of the cutting component, the first cutting blade cuts the food into slices, and the second cutting blades cut the sliced food into shreds.

In the technical solution of the aforementioned invention, in order to eject the cut food, a plurality of parallel ridges are provided on an inner wall of the housing. A side of the sliding member facing the housing is provided with a sliding channel. The ridges slidably cooperate with the sliding channel to guide the sliding of the ridges along the housing, and the ridges push out food within the sliding channel, preventing cut food from clogging the sliding channel or adhering to the housing. However, the aforementioned invention has the following defect: food residues may also remain on the cutting blades, which can cause the cutter to jam or damage the cutting blades, or damage the ridges during cutting, severely affecting the cutting effect.

### PRIOR ART DOCUMENT

### Patent Documents

Patent Document 1: Chinese Patent Publication No. CN108858317B

Patent Document 2: Chinese Patent Publication No. CN213731924U

### BRIEF DESCRIPTION OF DRAWINGS

The following detailed description of the embodiments of the present disclosure will be better understood when read in conjunction with the appended drawings. The present disclosure is illustrated by way of example, and not limited by the accompanying figures, in which like references indicate similar elements.

FIG. 1 is a schematic overall structural view of a food cutting device according to the present disclosure;

FIG. 2 is a schematic structural view of a second housing of the food cutting device shown in FIG. 1;

FIG. 3 is a schematic structural view of an ejection component of the food cutting device shown in FIG. 2;

FIG. 4 is a top view of the ejection component shown in FIG. 3, viewed from the height direction of the second housing;

FIG. 5 is a side view of the ejection component shown in FIG. 3, viewed from the width direction of the second housing;

FIG. 6 is a schematic structural view illustrating a connection between the second housing shown in FIG. 2 and a connecting assembly;

FIG. 7 is a rear view of the connection between the second housing and the connecting assembly shown in FIG. 6;

FIG. 8 is a partial schematic view of the connecting assembly shown in FIG. 6;

FIG. 9 is a schematic view illustrating a structure in the ejection component shown in FIG. 3 configured for cooperating with the connecting assembly shown in FIG. 6;

FIG. 10 is a cross-sectional schematic view at a connection position where the connecting assembly and the ejection component are connected, as shown in FIG. 2;

FIG. 11 is a schematic view illustrating a connection between the second housing shown in FIG. 2 and a connecting assembly in FIG. 1;

FIG. 12 is a front view of the connection between the second housing and the connecting assembly shown in FIG. 11;

FIG. 13 is a structural view of the connection between the second housing and the connecting assembly shown in FIG. 11, viewed from another perspective;

FIG. 14 is a schematic view illustrating a positional relationship between the ejection component shown in FIG. 3 and other main components;

FIG. 15 is another schematic view illustrating a positional relationship between the ejection component shown in FIG. 3 and other main components;

FIG. 16 is a cross-sectional view taken along line F-F in FIG. 7;

FIG. 17 is a front view of the second housing shown in FIG. 2;

FIG. 18 is a schematic view showing a separated state of the second housing and a shielding plate shown in FIG. 17;

FIG. 19 is a schematic view showing an assembled state of the second housing and a base shown in FIG. 17;

FIG. 20 is a schematic structural view of slide rail assemblies on both sides of the second housing shown in FIG. 19;

FIG. 21 is an enlarged view of portion B in FIG. 20;

FIG. 22 is a structural view of the food cutting device shown in FIG. 1, viewed from another perspective;

FIG. 23 is a top view of the food cutting device shown in FIG. 22;

FIG. 24 is a cross-sectional view taken along line A-A in FIG. 23;

FIG. 25 is a cross-sectional view taken along line B-B in FIG. 23;

FIG. 26 is a side view of the first housing shown in FIG. 11;

FIG. 27 is a cross-sectional view taken along line C-C in FIG. 26, locking blocks are retracted laterally;

FIG. 28 is a cross-sectional view taken along line D-D in FIG. 26, the locking blocks are retracted laterally;

FIG. 29 is a cross-sectional view taken along line C-C in FIG. 26, the locking blocks are extended laterally;

FIG. 30 is a cross-sectional view taken along line D-D in FIG. 26, the locking blocks are extended laterally;

FIG. 31 is a schematic structural view of a food pushing component applied to a material placing cylinder shown in FIG. 1;

FIG. 32 is a schematic structural view of the food pushing component shown in FIG. 31;

FIG. 33 is a structural view of the food pushing component shown FIG. 32, viewed from another perspective;

FIG. 34 is a schematic structural view of the food pushing component shown in FIG. 32, viewed from a bottom wall side;

FIG. 35 is a cross-sectional view taken along line E-E in FIG. 34;

FIG. 36 is an exploded view of the food pushing component shown in FIG. 32;

FIG. 37 is an exploded view showing a receiving box placed inside a storage box in FIG. 1;

FIG. 38 is a schematic structural view of a second housing of a food cutting device in the prior art.

### DETAILED DESCRIPTION

It should be understood by those skilled in the art that the following embodiments are merely for explaining the technical principles of the embodiments of the present disclosure and are not intended to limit the scope of protection of the embodiments of the present disclosure. Those skilled in the art can make adjustments as needed to adapt to specific application scenarios.

In the description of the embodiments of the present disclosure, it should be noted that unless otherwise explicitly specified and defined, the terms “connected” and “coupled” should be understood in a broad sense. For example, it may be a fixed connection, a detachable connection, or an integral connection; it may be a mechanical connection, an electrical connection; it may be a direct connection or an indirect connection through an intermediary. The specific meanings of the above terms in the embodiments of the present disclosure can be understood by those of ordinary skill in the art based on the specific context.

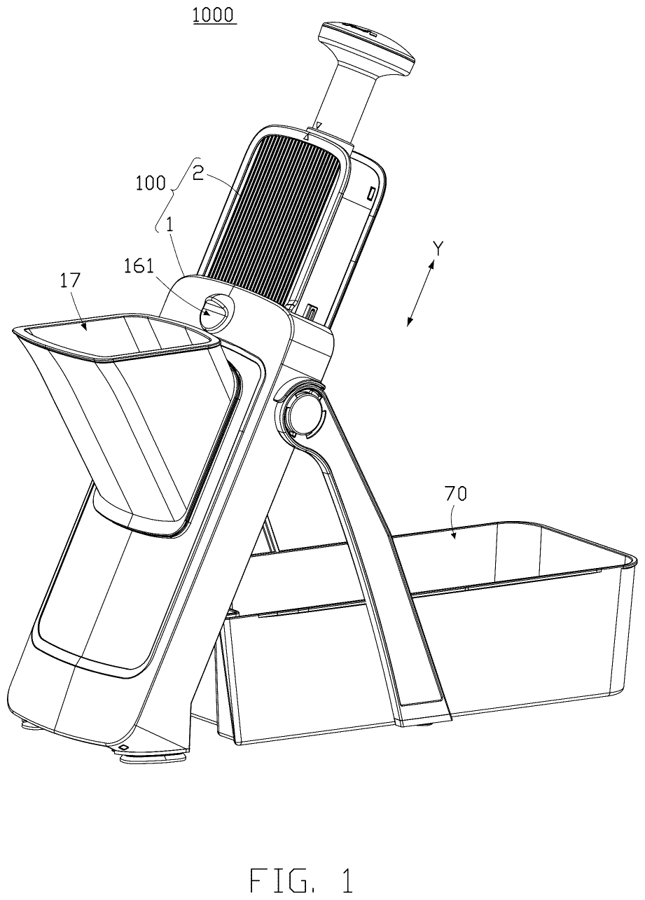

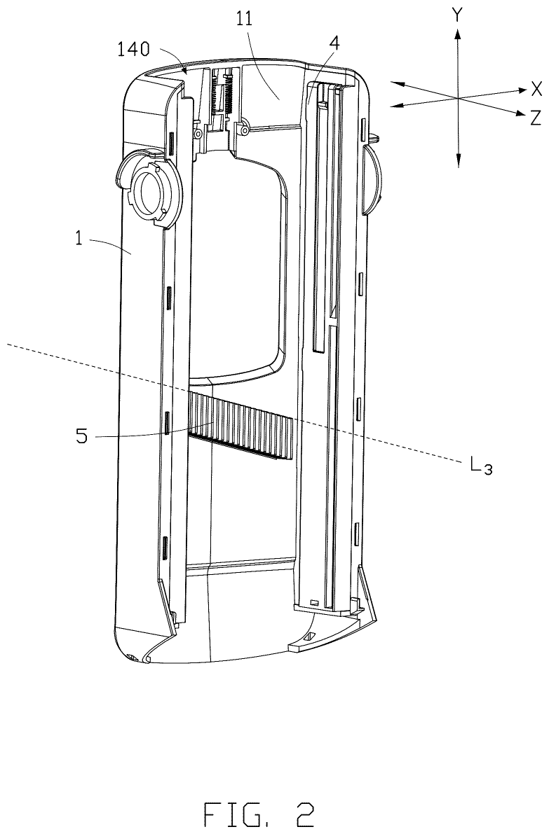

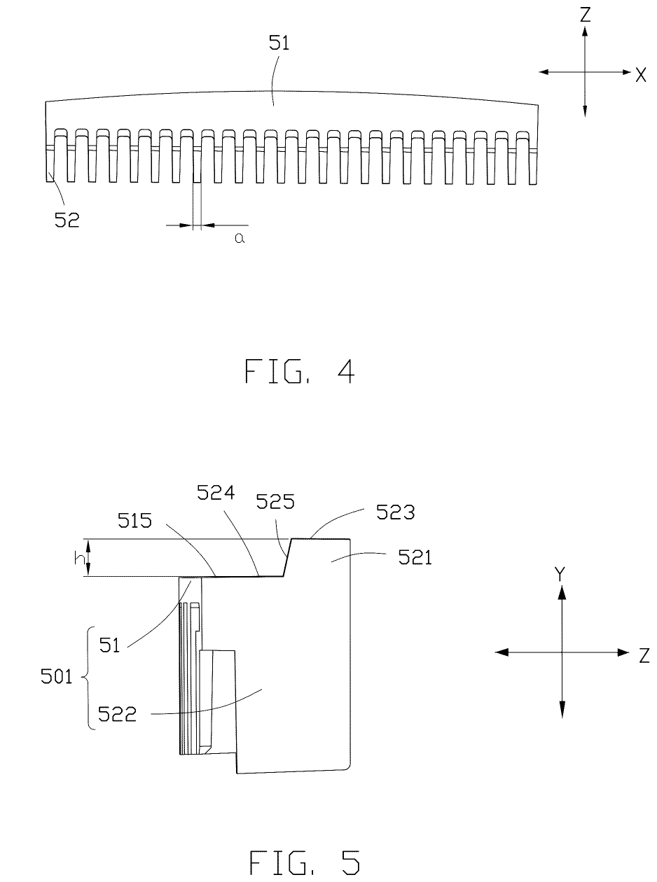

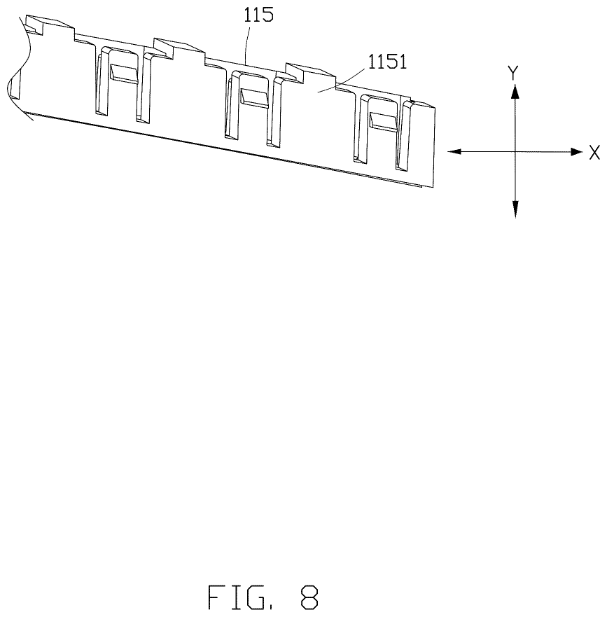

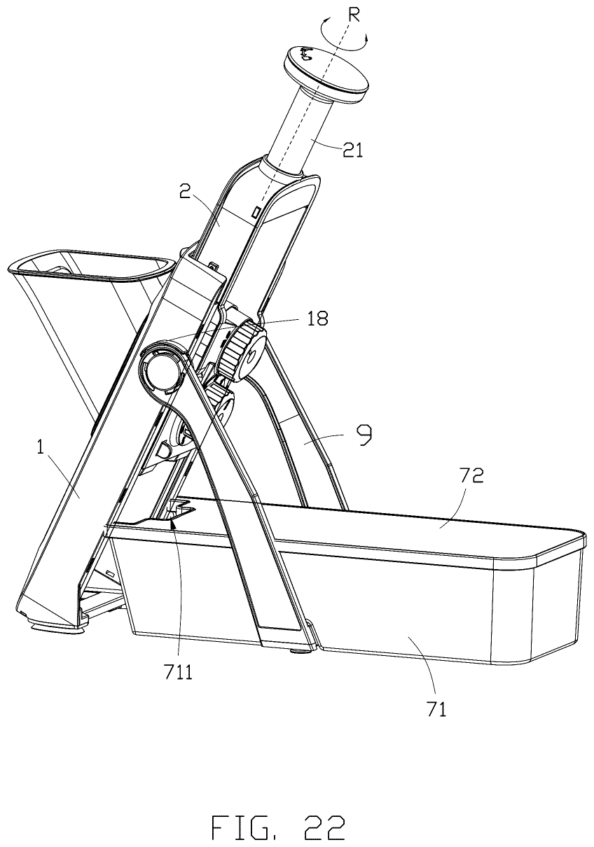

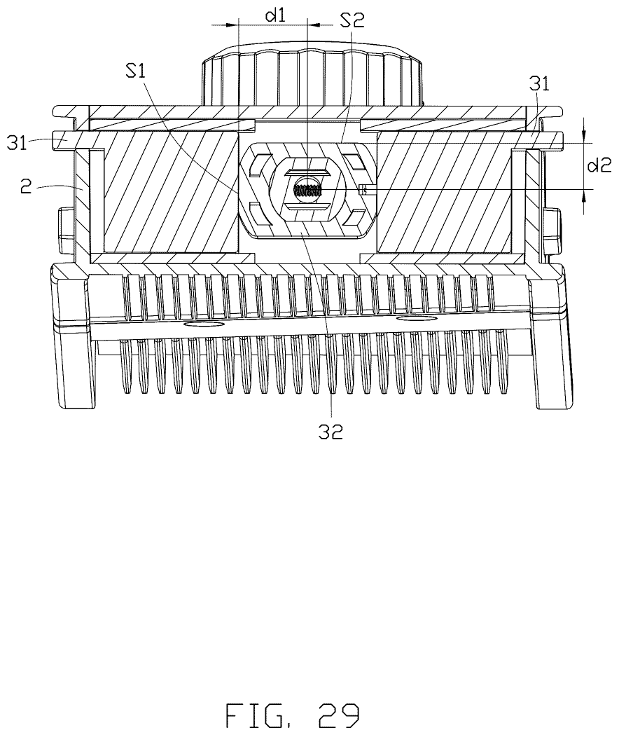

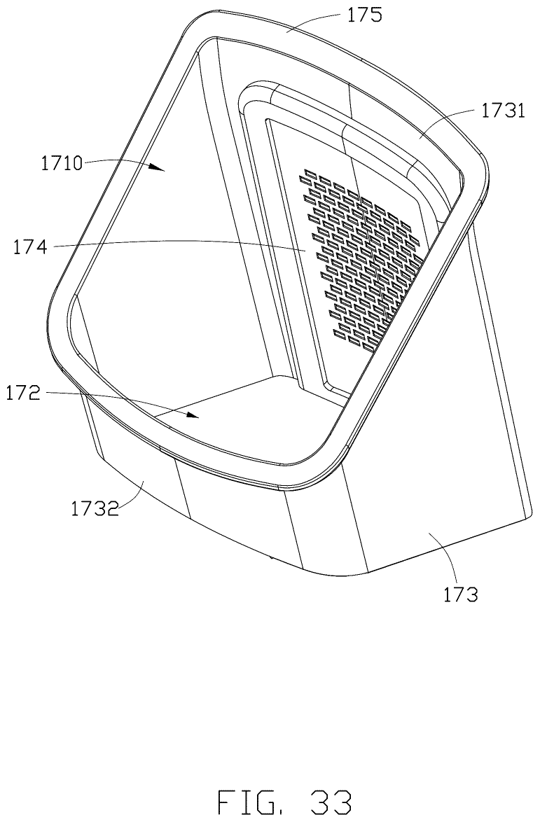

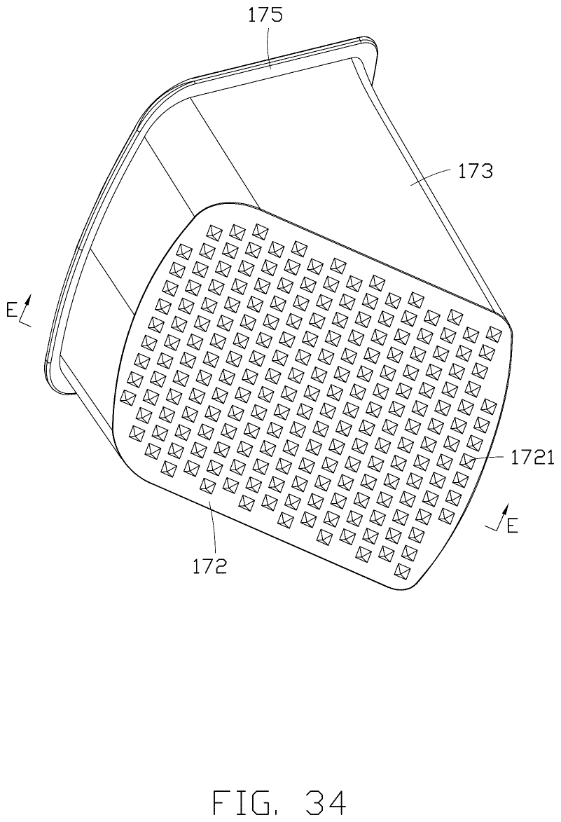

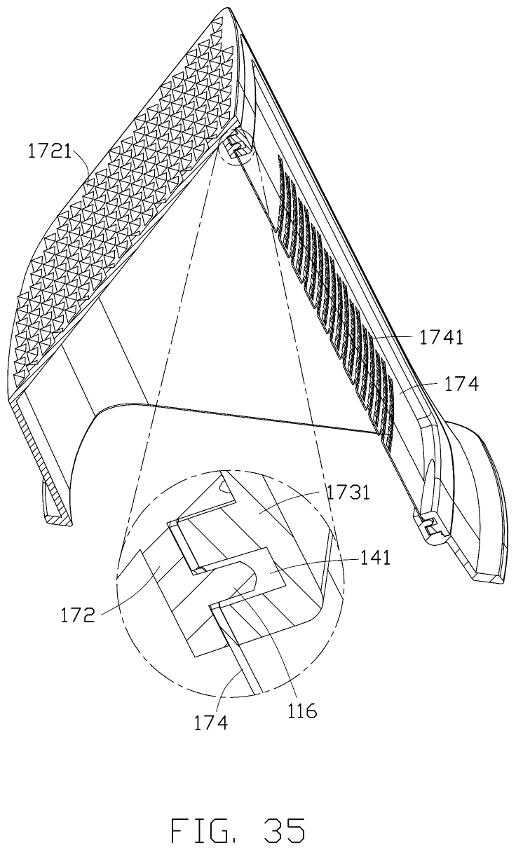

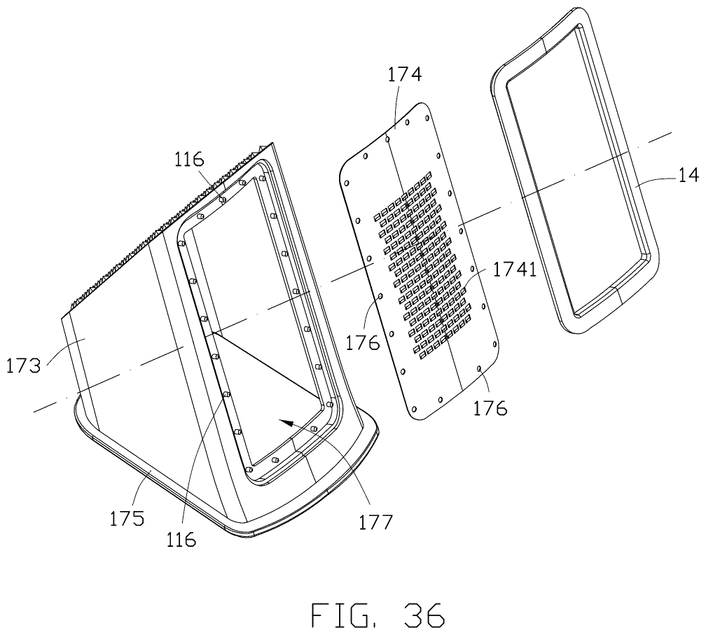

As shown in FIGS. 1 to 36, the food cutting device 1000 comprises a housing assembly 100 and a cutting assembly 200. The food cutting device 1000 is capable of performing multi-specification cutting. The detailed configuration of the food cutting device 1000 will be described in detail below. For ease of description, when viewing the food cutting device 1000 from a front side, a width direction of the housing assembly 100 is defined as the X-direction, a height direction of the housing assembly 100 is defined as the Y-direction, and a thickness direction of the housing assembly 100 is defined as the Z-direction, the X-direction, the Y-direction, and the Z-direction are perpendicular to each other, the front side of the housing assembly 100 is referred to as the forward side, and an opposite side is referred to as the rear side. During use, a user places uncut food into a material placing cylinder 17 (see FIG. 1) provided on the front side of the housing assembly 100. After the food is cut, it is ejected toward the rear side. In this embodiment, a cutting direction of the food cutting device 100 is parallel to the Y-direction.

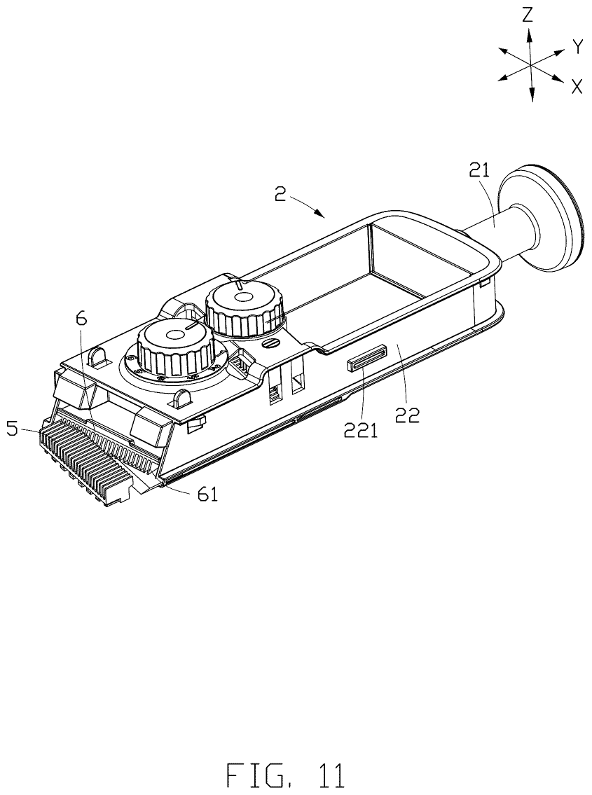

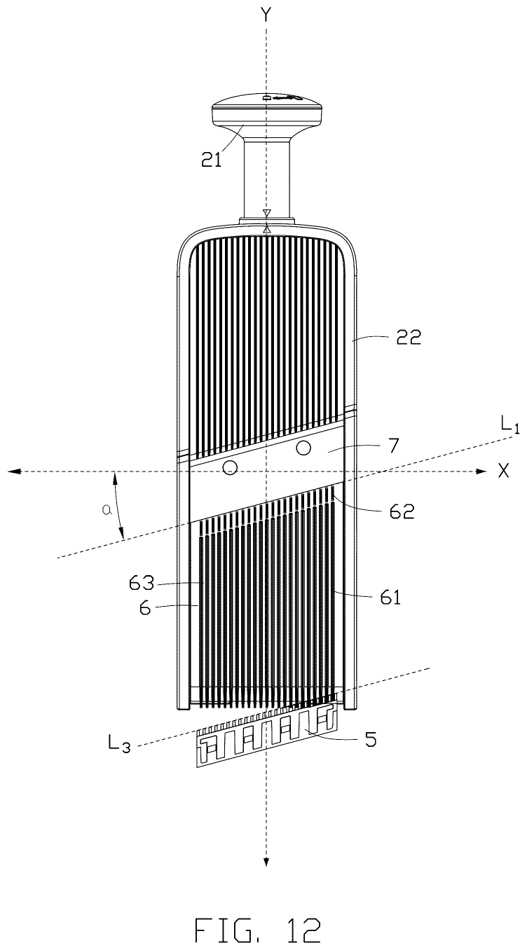

As shown in FIG. 1, the housing assembly 100 comprises a first housing 2 and a second housing 1. The first housing 2 is slidably attached to the second housing 1, allowing the first housing 2 to perform reciprocating linear motion relative to the second housing 1 along the height direction (Y-direction) of the housing assembly 100. A surface of the first housing 2 is provided with a bearing area for supporting the food. As shown in FIGS. 11 to 15, the cutting assembly 200 comprises a cutting component 210. The cutting component 210 is disposed on the first housing 2 and is positioned above the bearing area in the Y-direction to cut the food on the bearing area. The cutting component 210 comprises a first cutting blade 7 and a plurality of second cutting blades 8 whose cutting edge directions are perpendicular to each other. Since the cutting edge directions of the first cutting blade 7 and the plurality of second cutting blades 8 are perpendicular to each other, ingredients can be processed into slices, strips, or shreds.

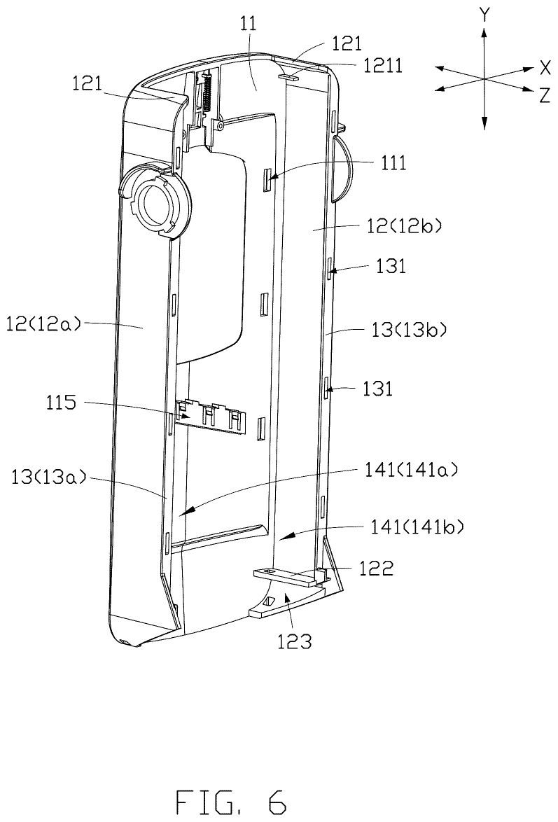

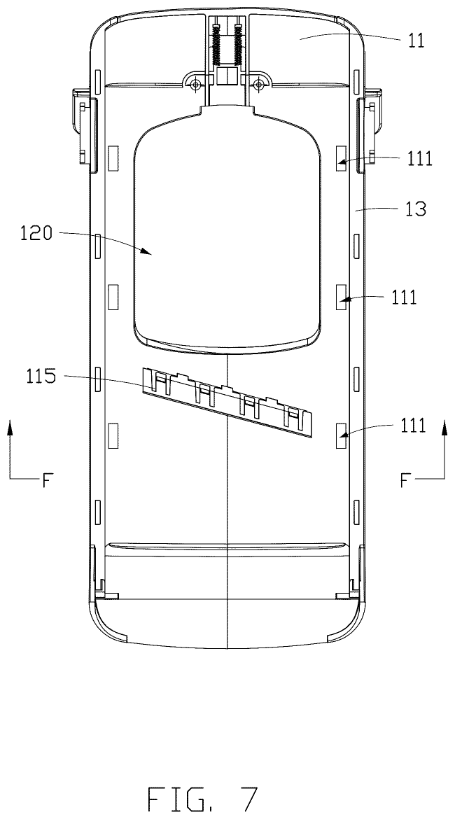

In some embodiments, as shown in FIGS. 6 and 7, the second housing 1 comprises a front wall 11, a first side wall 12a erected from one side of the front wall 11 toward the rear side, and a second side wall 12b erected from the other side of the front wall 11 toward the rear side. The front wall 11, the first side wall 12a, and the second side wall 12b each extend along the Y-direction, and the first side wall 12a and the second side wall 12b are opposed to each other in the X-direction. An accommodating groove 140 is defined by the front wall 11, the first side wall 12a, and the second side wall 12b. A part of the first housing 2 is accommodated in the accommodating groove 140. A feeding port 120 is formed through the front wall 11 for loading food to be cut. The food cutting device 1000 further comprises a material placing cylinder 17 (see FIG. 1). The material placing cylinder 17 is connected to the feeding port 120 on the front wall 11 of the second housing 1 and is located on a side facing away from the first housing 2 for storing uncut food. The food cutting device 1000 further comprises a receiving box 70 (see FIG. 1) disposed on the rear side of the first housing 2 for receiving the cut food ingredients.

The housing assembly 100 further comprises an ejection component 5 connected to the second housing 1. The ejection component 5 is located below the feeding port 120. The ejection component 5 is used to eject (clear) food residues remaining on the first housing 2 during the cutting process, preventing ingredients from jamming between the first housing 2 and the second housing 1, in gaps within the first housing 2, or on the blade edges of the cutting component 210, thereby affecting the smoothness of subsequent cutting.

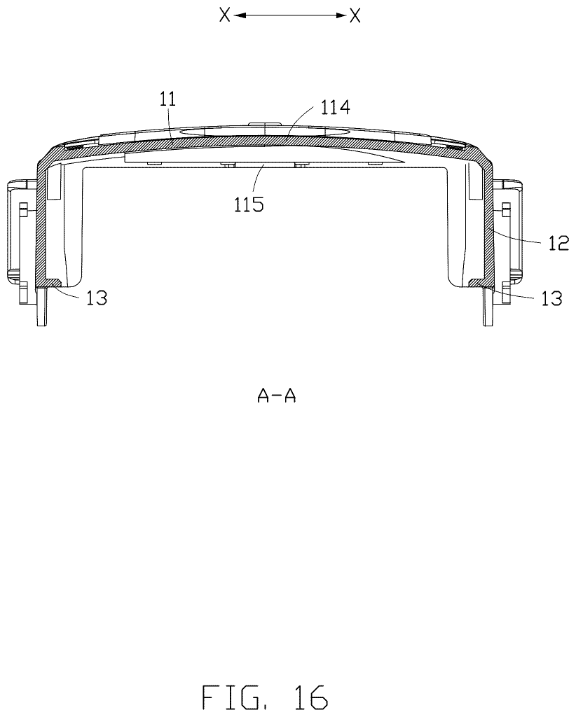

Before cutting, the bearing area faces the feeding port 120. Furthermore, as shown in FIGS. 12 to 14, the ejection component 5 and the cutting component 210 are disposed on opposite sides relative to the bearing area and the feeding port 120. Then, during a downward cutting stroke, the cutting component 210 moves with the first housing 2 toward the ejection component 5 until they are closest to each other, reaching a proximal position shown in FIG. 15, i.e., a lowermost point in the Y-direction of the stroke. The food on the bearing area between the ejection component 5 and the cutting component 210 is cut. During the return stroke, the cutting component 210 moves with the first housing 2 back to the state before cutting. At this time, as shown in FIGS. 12 to 14, the cutting component 210 is located at the distal end farthest from the ejection component 5 across the bearing area. During this process, the ejection component 5 is configured such that when the first housing 2 reciprocates once relative to the second housing 1 in the Y-direction, the ejection component 5 passes over the entire bearing area once, ensuring thorough cleaning.

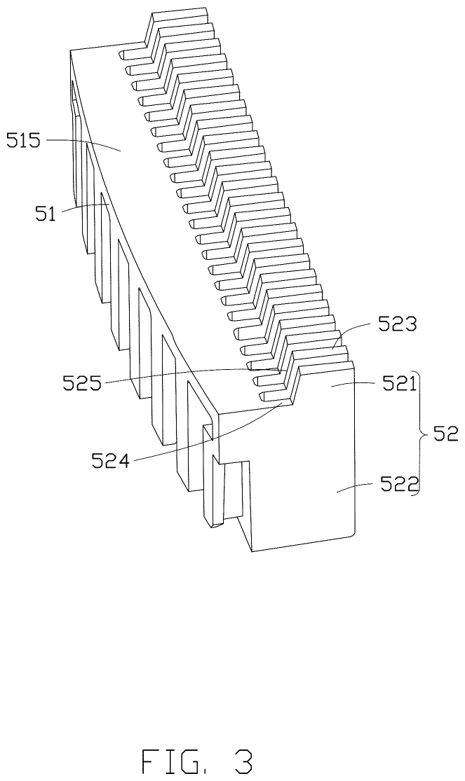

Hereinafter, the configuration of the ejection component 5 will be described in detail with reference to FIGS. 3 to 5.

The ejection component 5 is connected to a surface on the rear side of the front wall 11 of the second housing 1, so that the ejection component 5 can be disposed opposite the first housing 2 in the Z-direction. The ejection component 5 comprises a main body 501 and a plurality of projecting portions 521 protruding from the main body 501 along the height direction (Y-direction) of the second housing 1. The main body 501 comprises a base portion 51 and a plurality of tooth portions 522 connected to the base portion 51. Each tooth portion 522 extends from the base portion 51 along the thickness direction (Z-direction) of the second housing 1 away from the second housing 1 (i.e., toward the rear side). The plurality of tooth portions 522 are arranged on the base portion 51 at intervals along the width direction (X-direction). The projecting portions 521 protrude from the tooth portions 522 along the height direction (Y-direction) of the second housing 1 and extend beyond the base portion 51. Each projecting portion 521 is connected to the base portion 51 via a respective tooth portion 522. A height of the tooth portion 522 in the height direction (Y-direction) is greater than a height of the projecting portion 521 in the height direction (Y-direction), which can better ensure the mechanical strength of the projecting portion 521. Furthermore, each projecting portion 521 is connected via adjacent tooth portions 522 to form a step-like shape. The projecting portion 521 and the tooth portion 522 may collectively referred to as a rib 52. It can be said that the plurality of ribs 52 are arranged on the base portion 51 at intervals along the width direction (X-direction) of the second housing 1.

Each rib 52 has a top surface 523, which is the upper surface of the projecting portion 521 in the Y-direction. On the other hand, the tooth portion 522 has an upper surface 524 in the Y-direction, and the base portion 51 has an upper surface 515 in the Y-direction. Since the projecting portion 521 protrudes from the tooth portion 522 beyond the base portion 51, the ejection component 5 is configured such that the top surface 523 of the rib 52 is higher than the upper surface 515 of the base portion 51 in the Y-direction.

In some embodiments, the upper surface 515 of the base portion 51 and the upper surface 524 of the tooth portion 522 may be smoothly connected, for example, forming a single plane, but are not limited thereto. They may also form a chamfer or a curved surface to smoothly connect the surface of the projecting portion 521 near the base portion 51 side and the upper surface 515 of the base portion 51.

When the cutting component 210 moves relative the ejection component 5, the first cutting blade 7 is always disposed opposite the upper surface 524 of the tooth portion 522, with a gap formed between the cutting edge of the first cutting blade 7 and the back edge of each of the plurality of second cutting blades 8. Therefore, the opposing ejection component 5 and first cutting blade 7 in the Y-direction do not contact each other, thereby forming an avoidance area for the first cutting blade 7 above the projecting portion 521 and preventing the cutting blade of the cutting component 210 from contacting the base portion 51 and causing wear. In the Y-direction, the columns formed by the arrangement of the plurality of ribs 52 and the columns formed by the arrangement of the plurality of second cutting blades 8 are staggered relative to each other. Consequently, the gap between two adjacent ribs 52 can serve as avoidance areas for the second cutting blades 8, preventing the cutting blades of the cutting component 210 from contacting the base portion 51 and causing wear.

In some embodiments, in order to effectively clear food residues remaining on the cutting blades, the ejection component 5 is configured such that: in a case that the cutting assembly 200 moves to the proximal position closest to the ejection component 5 (i.e., when the cutting component 210 reaches the lowermost point (shown in FIGS. 11-14) during reciprocal sliding along the Y-direction relative to the second housing 1), in the Y-direction, the projecting portion 521 extends beyond both the back edge of each of the plurality of second cutting blades 8 and the cutting edge of the first cutting blade 7, and is spaced apart from the first cutting blade 7, wherein the second cutting blade 8 is located in a gap between two adjacent projecting portions 521, and the base portion 51 is spaced apart from the first cutting blade 7.

In some embodiments, the projecting portion 521 has an inclined surface 525 proximate to the base portion 51. The upper surface 524 of the tooth portion 522 is connected to the top surface 523 via this inclined surface 525. Furthermore, the inclined surface 525 is inclined such that as it gets closer to the top surface 523, it moves farther away from the base portion 51, and as it moves farther away from the main body 501, it moves farther away from the second housing 1. This configuration allows the inclined surface 525 to get as close as possible to the conical-shaped blade edge to eject food from the cutting blade while reducing food residues.

In the present disclosure, the width of the rib 52 in the X-direction is denoted as a, and the height of the projecting portion 521 of each rib 52 in the Y-direction is denoted as h (h is also the distance between a line connecting the projections of the top surfaces 523 in the thickness direction (Z-direction) of the second housing 1 and a line formed by the projection of the upper surface 515 of the base portion 51 in the Z-direction).

In some embodiments, to ensure structural strength and cleaning effectiveness, the rib 52 is configured such that a relationship between the a and the h satisfies: 1.0 mm≤h≤6.0 mm when 1.0 mm≤a≤1.8 mm (suitable for cutting ingredients into shreds); 1.0 mm≤h≤8.0 mm when 1.8 mm<a≤3.3 mm (suitable for cutting ingredients into strips).

When the width a of the rib 52 falls within the range of 1.0 mm≤a≤1.8 mm, the rib 52 is relatively thin. Chinese cuisine often processes ingredients into “thin shreds.” To reliably eject such shredded ingredients cut by the food cutting device 1000, a thinner rib is more suitable. The range 1.0 mm≤a≤1.8 mm is a dimension range summarized based on practical production experience and also accounts for processing tolerances associated with thin-shreds. Within this width range, practical cutting tests were conducted on the height h of the projecting portion 521 of the rib 52. One cycle of “downward cutting—return stroke” of the cutting component 210 of the food cutting device 1000 is recorded as one cutting operation (i.e., one reciprocation). After 30,000 test cycles, it was concluded that: if h<1.0 mm, the clearance area above the projecting portion 521 is insufficient, making the first cutting blade 7 prone to impact or cutting into the base portion 51, leading to wear on both; if h>6.0 mm, the rib 52 becomes excessively slender overall, resulting in insufficient strength and a tendency to deform under impact. Therefore, limiting h to 1.0 mm≤h≤6.0 mm allows the relatively thin rib 52 to possess adequate durable strength, preventing tilting or breakage after long-term use, while also ensuring that it can effectively avoid the first cutting blade 7 and successfully eject ingredients.

When the width a of the rib 52 falls within the range of 1.8 mm<a≤3.3 mm, the rib 52 is suitable for reliably ejecting “strip-shaped” ingredients cut by the food cutting device 1000. The range 1.8 mm<a≤3.3 mm is a dimension range summarized based on practical production experience and also accounts for machining tolerances associated with thicker strips. Within the range of 1.8 mm<a≤3.3 mm, practical cutting tests were conducted on the h of the rib 52. One cycle of “downward cutting-return stroke” of the cutting component 210 is recorded as one cutting operation. After 30,000 cutting test cycles, it was concluded that: if h<1.0 mm, the avoidance area above the projecting portion 521 is too narrow making it easy for the cutting blade to impact or cut into the base portion 51; if h>8.0 mm, the rib 52 becomes overly long, and the increase in strength from widening the rib 52 is insufficient to offset the impact force from ingredients, making the rib 52 prone to deformation under ingredient impact. Limiting h to 1.0 mm≤h≤8.0 mm allows the thicker rib 52 to have sufficient durable strength, preventing it from becoming skewed or breaking after long-term use, while also reducing the impact of ingredients on the base portion 51 and enabling the rib 52 to successfully avoid the cutting blade and effectively eject ingredients.

In some embodiments, the width a of the rib 52 is 1.3 mm, and the distance h in the Y-direction between the rib top end 523 and the upper surface 515 of the base portion 51 is 3.2 mm.

In some embodiments, the width a of the rib 52 is 2.4 mm, and the distance h in the Y-direction between the rib top end 523 and the upper surface 515 of the base portion 51 is 6.0 mm.

In some embodiments, the ejection component 5 is configured as an integrally formed structure. This facilitates separate precise machining and subsequent replacement, and also allows for selecting a material with higher toughness and hardness for the ejection component 5 independently from the housing assembly 100. Consequently, the structural strength of the ejection component 5 can be ensured, preventing deformation of the ejection component 5 due to impact from ingredients during prolonged cutting and avoiding cutting operation jams.

In some embodiments, as shown in FIGS. 6 to 8, the housing assembly 100 further comprises a connector 115 disposed on the surface on the rear side of the front wall 11 of the second housing 1. The connector 115 is used to connect the ejection component 5 to the second housing 1. The connector 115 may be a specific area on the second housing 1 or other structures for forming the connection. The two can be fixedly connected, making it difficult to detach the second housing 1 and the ejection component 5 without damage after connection. Connection methods include heat welding, ultrasonic welding, non-detachable snap-fitting, etc. Fixed connection can maximize the stability of the connection between the ejection component 5 and the second housing 1, preventing the ejection component 5 from loosening after long-term force application.

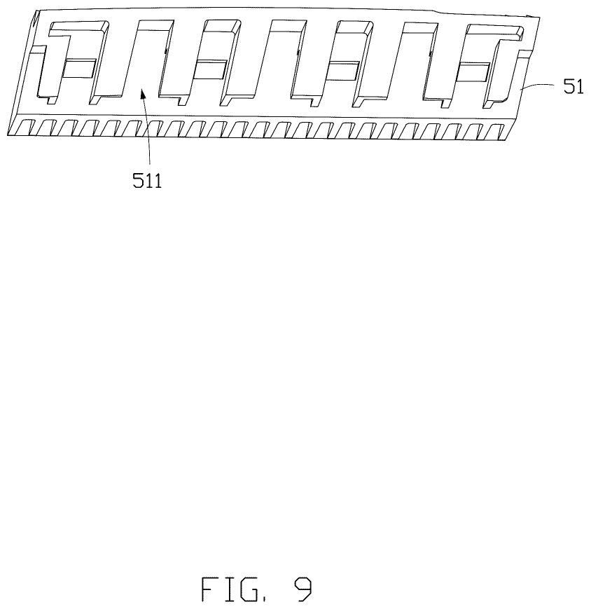

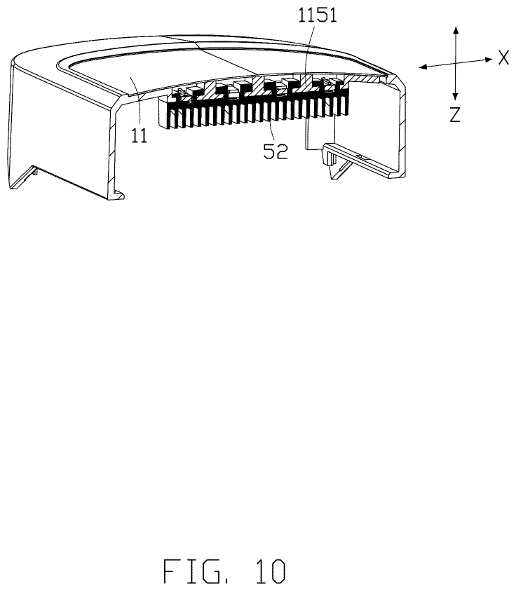

Furthermore, the connector 115 comprises a plurality of insertion strips 1151. The plurality of insertion strips 1151 are protruding and connected to the surface on the rear side of the front wall 11 of the second housing 1 and are arranged at intervals along the width direction (X-direction) of the front wall 11. As shown in FIG. 9, the base portion 51 of the ejection component 5 comprises a plurality of insertion slots 511 for cooperatively connecting with the insertion strips 1151. The plurality of insertion slots 511 are formed in a side of the base portion 51 proximate to the front wall 11 and open toward the side opposite to the side where the projecting portions 521 are located. As shown in FIG. 10, the plurality of insertion slots 511 and the plurality of insertion strips 1151 are cooperatively connected in a one-to-one correspondence. Each insertion slot 511 allows a corresponding insertion strip 1151 to be inserted downwardly in the Y-direction. In this way, even if the ejection component 5 is subjected to a downward impact force from ingredients, the insertion strips 1151 will not detach from the insertion slots 511.

Furthermore, after insertion, additional fixing methods such as ultrasonic welding or adhesive bonding can be used to further secure the connection, ensuring that the ejection component 5 is firmly connected to the second housing 1 and will not detach from the second housing 1 when subjected to a downward impact force from ingredients.

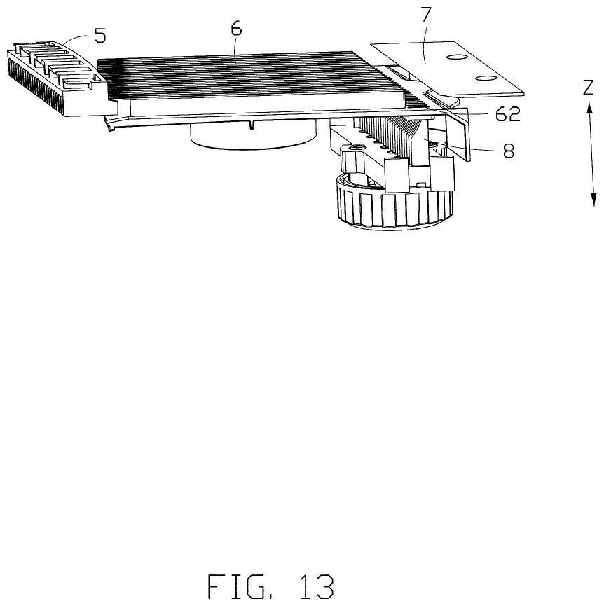

In some embodiments, as shown in FIGS. 13 to 15, the first housing 2 comprises a cutting frame 22 for mounting the cutting component 210 and a guide plate 6 provided with the bearing area. The first cutting blade 7 is mounted on the cutting frame 22 such that its cutting edge faces the upper surface 524 of the tooth portion 522 of the ejection component 5. The cutting edge of the first cutting blade 7 extends along the width direction (X-direction) of the cutting frame 22 for laterally cutting (slicing) food ingredients. The plurality of second cutting blades 8 are connected to the cutting frame 22 and are arranged at intervals along the X-direction. Their blade surfaces extend along the thickness direction (Z-direction) of the cutting frame 22 for longitudinally cutting (slicing into strips) food ingredients. The second cutting blades 8 cooperate with the first cutting blade 7 such that the cutting edge of the first cutting blade 7 is disposed opposite the back edge of each second cutting blade 8 with a predetermined interval, ensuring no interference between them during the cutting process while enabling multi-specification cutting of ingredients.

In some embodiments, the overall orientation of the first cutting blade 7, the plurality of second cutting blades 8, and the ejection component 5 is the same, and they are inclined relative to the width direction, i.e., the X-direction. In other words, the extension direction of the cutting edge of the first cutting blade 7, the arrangement direction of the cutting edges of the plurality of second cutting blades 8, and the arrangement direction of the plurality of top surfaces 523 of the ejection component 5 are parallel. For example, as shown in FIG. 13, an extension line L1 (the extension direction of the cutting edge) of the cutting edge of the first cutting blade 7 forms an acute angle α with the X-direction, and the extension line L1 (the arrangement direction of the cutting edge) of the cutting edge of the first cutting blade 7 is parallel to a connection line L3 (the arrangement direction) of the top surfaces 523 of the ribs 52. This facilitates the first cutting blade 7 gradually cutting into the ingredients while cooperating with the ejection component 5 to simultaneously eject strip-shaped ingredients, avoiding jamming.

In some embodiments, the guide plate 6 is provided with a plurality of guide ribs 61 extending along the Y-direction and arranged at intervals along the X-direction. A guide sliding groove 63 is formed between two adjacent guide ribs 61. The ribs 52 are movable along the guide sliding grooves 63. Each second cutting blade 8 corresponds in a position to a respective guide rib 61. The corresponding second cutting blade 8 and guide rib 61 are located on the same straight line in the Y-direction. The above structure ensures that the second cutting blades 8 can accurately enter the gaps between each two adjacent ribs 52, guaranteeing smooth cutting. In a case that the cutting assembly 200 moves to a distal position farthest from the ejection component 5 (i.e., when the cutting component 210 reaches an uppermost point during reciprocal sliding along the Y-direction relative to the second housing 1), each second cutting blade 8 is away from the ejection component 5, the cutting edge of the first cutting blade 7 faces the ribs 52, and at least a portion of at least one rib 52 is located within the guide sliding groove 63. This ensures that the guide sliding groove 63 limits and guides the rib 52, thereby ensuring smooth movement of the first housing 2. In the case that the cutting assembly 200 moves to the proximal position closest to the ejection component 5, in the Y-direction, the projecting portion 521 extends beyond the back edge of each of the plurality of second cutting blades 8 and the cutting edge of the first cutting blade 7, and is spaced apart from the first cutting blade 7. Here, the second cutting blade 8 is located in a gap between corresponding two adjacent projecting portions 521, and the base portion 51 is spaced apart from the first cutting blade 7. Furthermore, the upper surface 515 of the base portion 51 may protrude more toward the second cutting blade 8 than the surface of the guide rib 61.

The guide plate 6 is movably connected to the cutting frame 22. The guide plate 6 is provided with blade entry slots 62 for the second cutting blades 8 to pass through. The cutting edges of the second cutting blades 8 pass through the blade entry slots 62, thereby positioning the cutting edges of the second cutting blades 8 higher than the first cutting blade 7 (in the Z-direction). This ensures that ingredients are cleanly cut. For this purpose, an avoidance groove 526 recessed toward the base portion 51 side may be provided on a bottom surface of the ejection component 5 between each two adjacent ribs 52. When the first housing 2 moves to the proximal position, the avoidance groove 526 accommodates a part of the cutting edge of the second cutting blade 8, preventing interference between the second cutting blade 8 and the ejection component 5.

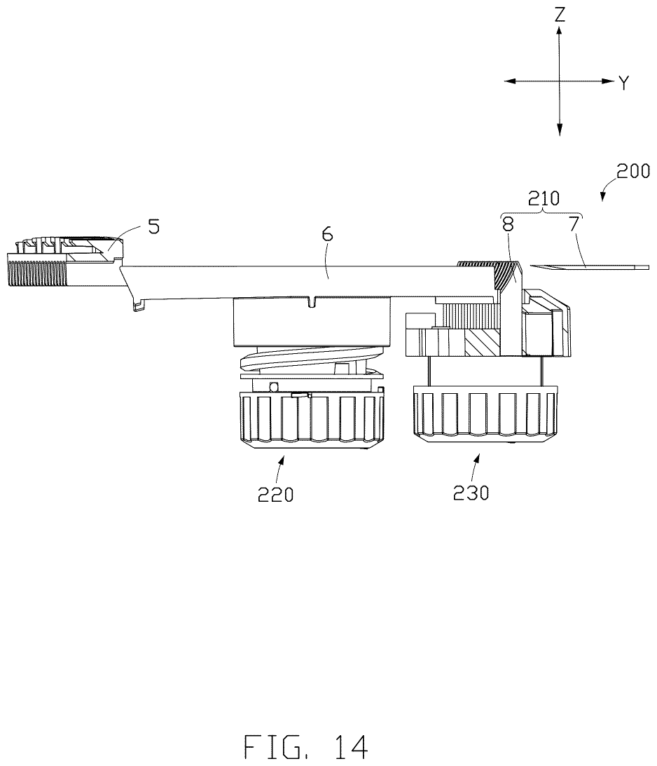

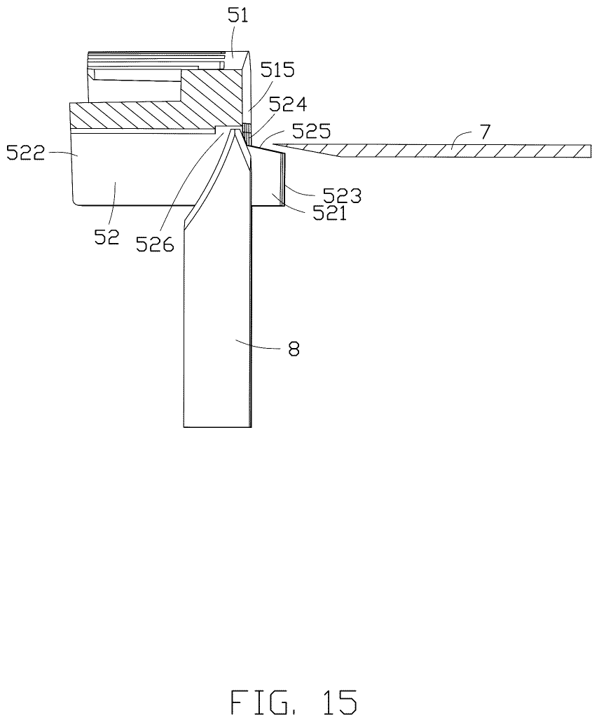

The cutting assembly 200 further comprises a blade adjusting member 230. The blade adjusting member 230 is connected to the second cutting blades 8 and is used to adjust the position of the second cutting blades 8 in the Z-direction, thereby enabling the retraction and extension of the second cutting blades 8. As shown in FIG. 13, the second cutting blades 8 are retracted into the blade entry slots 62. At this time, the second cutting blades 8 do not participate in cutting, and the first cutting blade 7 alone performs slicing. As shown in FIG. 14, when the second cutting blades 8 are extended, they pass through the blade entry slots 62 so that the cutting edges of the second cutting blades 8 are higher than the first cutting blade 7 in the Z-direction (i.e., the second cutting blades 8 are closer to the second housing 1 compared to the first cutting blade 7), and the cutting edges of the second cutting blades 8 face the gaps between two adjacent ribs 52 in the ejection component 5. The second cutting blades 8 cooperate with the first cutting blade 7 to cut strips and shreds.

Depending on cutting needs, the number and/or spacing of the second cutting blades 8 can be adjusted, thereby changing the cutting width of the food to adapt to different ingredient processing requirements. When all second cutting blades 8 are retracted, their cutting edges are withdrawn into the blade entry slots 62 and do not participate in cutting. At this time, the first cutting blade 7 alone performs slicing.

In some embodiments, during the adjustment process of the second cutting blades 8, the horizontal distance in the Y-direction between the back edge of each of the plurality of second cutting blades 8 and the cutting edge of the first cutting blade 7 remains unchanged, ensuring the stability of the second cutting blades 8.

The cutting assembly 200 further comprises a thickness adjusting member 220. The thickness adjusting member 220 is connected to the guide plate 6 and can adjust the position of the guide plate 6 in the Z-direction relative to the first cutting blade 7. Since the guide plate 6 cooperates with the cutting component 210, after adjusting the position of the guide plate 6 in the Z-direction, the distance between the ingredient and the first cutting blade 7 and the guide plate 6 in the Z-direction can be changed, thereby adjusting the cutting thickness to achieve cutting processing of different thicknesses.

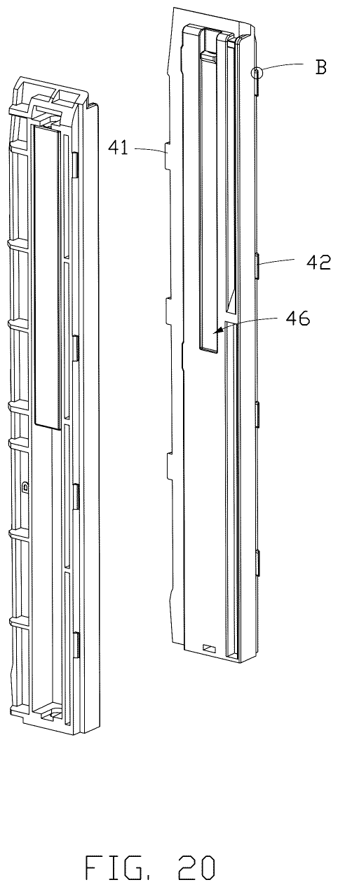

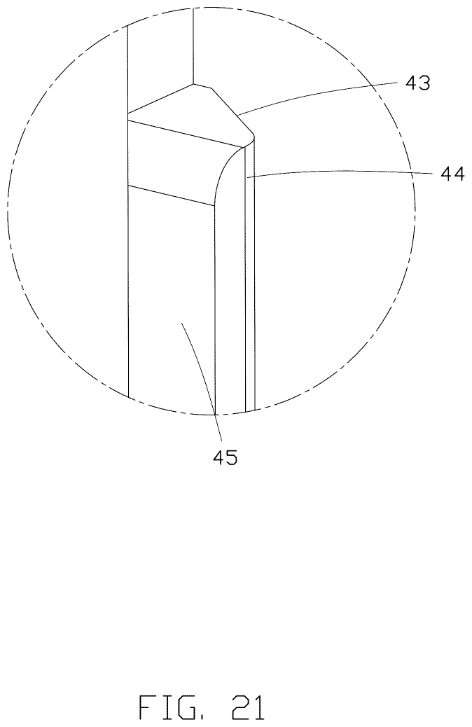

In some embodiments, as shown in FIGS. 6 and 7, the second housing 1 may further comprise a first limiting wall 13a and a second limiting wall 13b. The first limiting wall 13a protrudes from an end of the first side wall 12a away from the front wall 11 toward the side of the second side wall 12b. The second limiting wall 13b protrudes from an end of the second side wall 12b away from the front wall 11 toward the side of the first side wall 12a. Consequently, the front wall 11, the first side wall 12a, and the first limiting wall 13a together enclose a first accommodating cavity 141a. The front wall 11, the second side wall 12b, and the second limiting wall 13b together enclose a second accommodating cavity 141b. The two accommodating cavities 141 are symmetrically arranged. As shown in FIGS. 19 and 20, a slide rail assembly 4 is disposed in each of the first accommodating cavity 141a and the second accommodating cavity 141b for guiding the first housing 2 to slide smoothly relative to the second housing 1 in the Y-direction.

It should be noted that sometimes, when not distinguishing between the first side wall and the second side wall, only reference numeral “12” is used for explanation. Similarly, when not distinguishing between the first limiting wall and the second limiting wall, only reference numeral “13” is used. When not distinguishing between the first accommodating cavity and the second accommodating cavity, only reference numeral “141” is used.

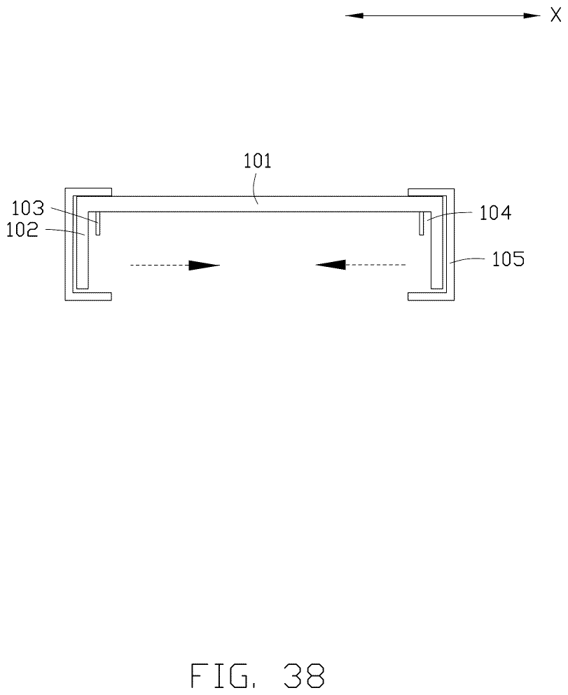

In some embodiments, the front wall 11, the two side walls 12, and the two limiting walls 13 in the second housing 1 are of an integrally formed structure. Therefore, there is no need to additionally assemble a side base 105 on the housing assembly 100, thus avoiding the phenomenon of seizing or jamming of the housing due to poor fit between the housing and the side base 105 as shown in FIG. 38 of the prior art. In the present disclosure, at least the front wall 11, the two side walls 12, and the two limiting walls 13 are of an integrally formed structure, which facilitates achieving high precision. Consequently, the food cutting device 1000 employing this housing assembly 100 does not experience jamming and operates very smoothly and seamlessly. It also reduces assembly difficulty and improves production efficiency. Moreover, because there is no assembly gap between the side base 105 and the housing assembly 100, the structure is more compact and saves material costs. Thus, even after long-term use, the food cutting device 1000 rarely produces abnormal noise or wobbles, and certainly will not fall apart, providing an excellent user experience. Furthermore, the front wall 11 may also be integrally formed with the connector 115.

In some embodiments, the slide rail assembly 4 is provided with a slide groove 46 extending along the Y-direction. By causing two sliders 221 provided on both sides surface of the first housing 2 to slide within two slide grooves 46, the first housing 2 can be guided to slide smoothly relative to the second housing 1 in the Y-direction. Furthermore, an elastic member may be provided inside the slide rail assembly 4. The elastic member acts on the slider 221 provided on the side surface of the first housing 2, guiding the first housing 2 to slide smoothly relative to the second housing 1 while also achieving automatic elastic reset of the first housing 2 after being pressed down, resulting in a labor-saving effect and ensuring smooth cutting operation.

Furthermore, upper and lower limit plates 121 and 122 extending toward the other side wall 12 are respectively provided on the upper and lower parts of each of the two side walls 12. The slide rail assembly 4 is limited between the upper limit plate 121 and the lower limit plate 122. The upper and lower limit plates 121 and 122 cooperate to position the slide rail assembly 4 in its height direction (Y-direction).

Furthermore, an arc-shaped transition surface is provided between an inner wall of the upper limit plate 121 of the second housing 1 and the inner wall of the side wall 12. The lower limit plate 122 is perpendicular to the side wall 12. The lower limit plate 122 being perpendicular to the side wall 12 can effectively limit the slide rail assembly 4 in the Y-direction to prevent it from sliding out and can withstand the impact force during operation of the first housing 2. The arc-shaped transition surface between the inner wall of the upper limit plate 121 and the inner wall of the side wall 12 allows the upper end of the slide rail assembly 4 to slide smoothly into the accommodating cavity 141, facilitating assembly production and helping to improve production efficiency. At the same time, a positioning plate 1211 is protruding from the inner wall of the upper limit plate 121. When the slide rail assembly 4 is limited between the upper limit plate 121 and the lower limit plate 122, the positioning plate 1211 is inserted into a positioning groove on the slide rail assembly 4 to further position the slide rail assembly 4.

In some embodiments, to ensure stable installation of the slide rail assembly 4, at least two snap-fit holes are provided on both the front wall 11 and the limiting wall 13, and the slide rail assembly 4 is provided with snap-fit protrusions that engage with the snap-fit holes for positioning. Specifically, at least two first snap-fit holes 111 are provided on the front wall 11 at intervals along the Y-direction, and at least two second snap-fit holes 131 are provided on the limiting wall 13 at intervals along the Y-direction. The slide rail assembly 4 is provided with a first snap-fit protrusion 41 on its front side for engaging with the first snap-fit holes 111 and a second snap-fit protrusion 42 on its rear side for engaging with the second snap-fit holes 131, achieving positioning of the slide rail assembly 4 in the X-direction within the second housing 1 and preventing the slide rail assembly 4 from detaching from the accommodating cavity 141.

Furthermore, at least two first snap-fit holes 111 are provided on the front wall 11 at intervals along the height direction (Y-direction) of the front wall 11. At least two second snap-fit holes 131 are provided on the limiting wall 13 at intervals along the Y-direction. The front side of the slide rail assembly 4 is provided with the first snap-fit protrusion 41 for positioning engagement with the first snap-fit holes 111, and the rear side of the slide rail assembly 4 is provided with the second snap-fit protrusion 42 for positioning engagement with the second snap-fit holes 131.

Furthermore, a surface of each snap-fit protrusion proximate to its corresponding side wall 12 has a guiding inclined surface 43. A surface of each snap-fit protrusion away from the corresponding side wall 12 is a stop surface 45. When the snap-fit protrusion enters the snap-fit hole, the stop surface 45 abuts against the wall of the snap-fit hole.

The guiding inclined surface 43 is used to abut against the inner wall of the front wall 11 or the inner wall of the limiting wall 13 to guide the snap-fit protrusion into the snap-fit hole. When assembling the slide rail assembly 4, it is gradually pushed into the accommodating cavity 141 from its open face (inner side face). During the process of the slide rail assembly 4 entering the accommodating cavity 141, the guiding inclined surface 43 abuts the inner wall of the front wall 11 or the inner wall of the limiting wall 13, allowing the snap-fit protrusion to gradually move into the snap-fit hole. To prevent the slide rail assembly 4 from detaching from the inner opening of the accommodating cavity 141, snap-fit holes are provided on the front wall 11 and the limiting wall 13 to engage with the snap-fit protrusions on the slide rail assembly 4. The snap-fit holes do not form an obstacle on the demolding path, allowing the second housing 1 to be integrally formed using a mold, enhancing the strength and stability of the second housing 1 and making it more durable. Those skilled in the art can understand that after the snap-fit protrusions on the outer wall of the slide rail assembly 4 engage with the snap-fit holes on the front wall 11 or the limiting wall 13, these snap-fit holes will limit the slide rail assembly 4 laterally (in the X-direction) to prevent it from detaching from the accommodating cavity 141.

In this embodiment, a transition rounded corner 44 is provided between the guiding inclined surface 43 and the stop surface 45 to reduce friction between the snap-fit protrusion and the snap-fit hole and facilitate the entry of the snap-fit protrusion into the snap-fit hole.

In some embodiments, as shown in FIG. 16, the front wall 11 comprises an arc-shaped wall 114 bulging forward. The ejection component 5 is disposed on the inner side of the arc-shaped wall 114. The arc-shaped wall 114 provides sufficient space in the Z-direction for installing the ejection component 5 on the inner side of the front wall 11, preventing the ejection component 5 from being positioned too close to the cutting blades of the cutting component 210 and being damaged by cutting.

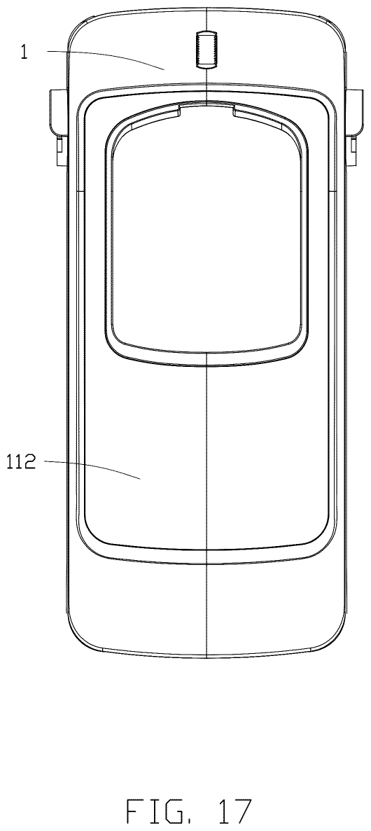

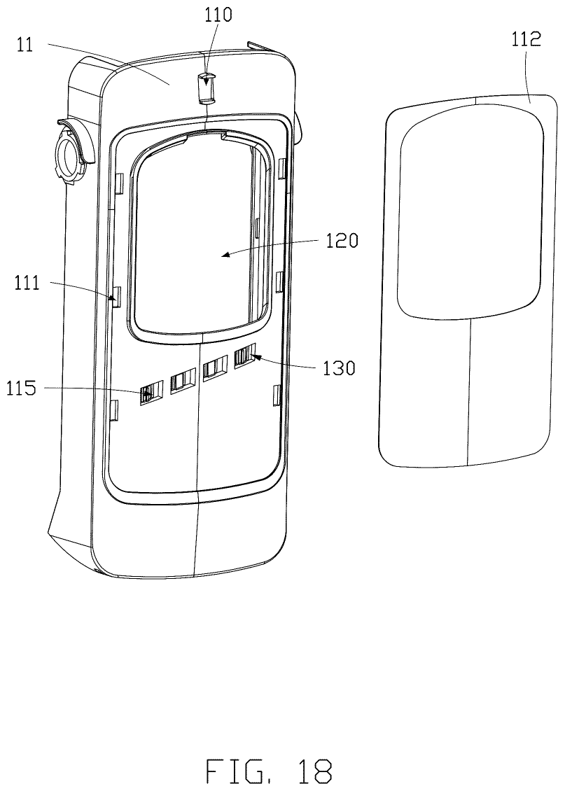

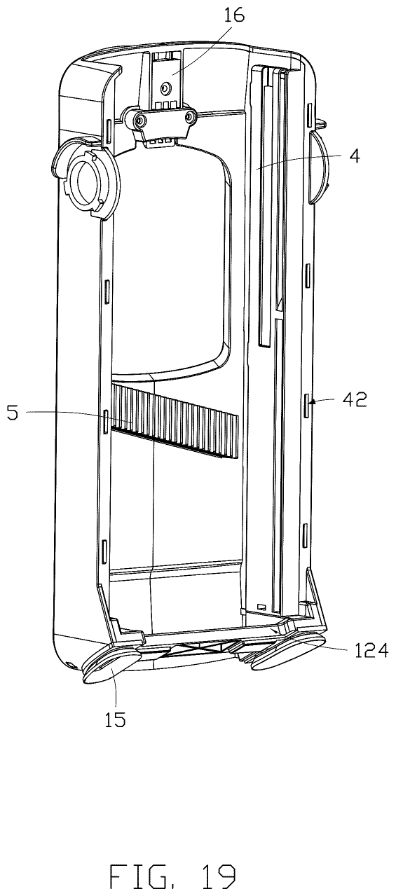

In some embodiments, as shown in FIGS. 17 to 18, a shielding plate 112 is provided on the outer surface of the front wall 11. The shielding plate 112 covers the ejection component installation hole 130 and the first snap-fit holes 111. The shielding plate 112 may cover the holes to prevent dust entry, and decorative patterns or trademarks may be printed on the shielding plate 112 to improve the aesthetics of the food cutting device 1000. The shielding plate 112 is connected to the front wall 11 by methods such as ultrasonic welding, adhesive bonding, screw connection, etc.

In some embodiments, as shown in FIG. 6, an installation cavity 123 for installing a base is provided below the lower limit plate 122 of the second housing 1. Further, as shown in FIG. 19, the base comprises a flexible buffer pad 15 and a bottom bracket 124. Two ends of the bottom bracket 124 in the X-direction are installed within the installation cavity 123, and the flexible buffer pad 15 is embedded within the bottom bracket 124 and the installation cavity 123. The flexible buffer pad 15 is used to buffer the impact on the second housing 1 from the cutting component 210, preventing wear on the bottom of the second housing 1.

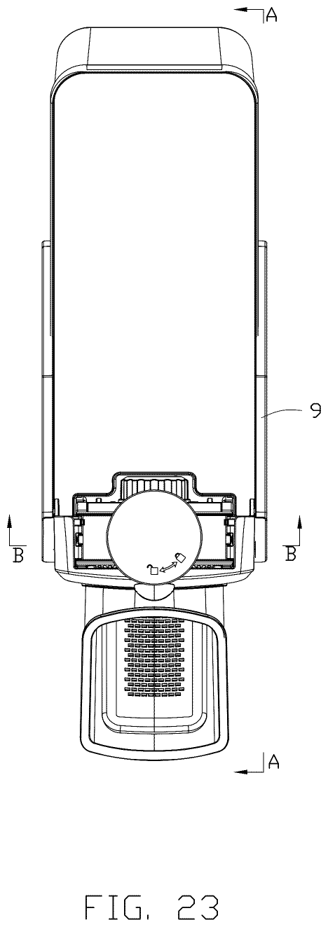

In some embodiments, as shown in FIGS. 22 and 23, the housing assembly 100 further comprises a support bracket 9 pivotally connected to the outer side of the side wall 12 of the second housing 1. On the support bracket 9, one or more damping member 9 is provided, with the second housing 1 having at least two recessed portions 19 along the rotation trajectory of the damping member 9b. A head 9b1 of the damping member 9b is extendable into the recessed portions 19 to restrict the rotation of the support bracket 9. The head 9b1 may be, for example, a convex point form, though the present disclosure is not limited thereto, and a protruding point structure may also be a convex feature.

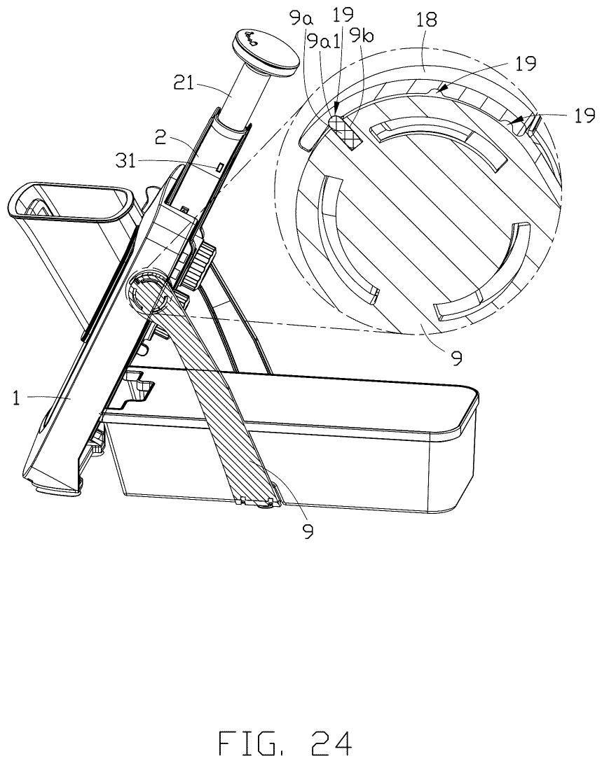

Specifically, as shown in FIG. 24, portions of the second housing 1 on both sides adjacent to the support bracket 9 extend outward to form extension portions 18. The recessed portions 19 are provided on the extension portions 18 and are at least two in number. For example, three recessed portions 19 are provided, corresponding to different rotation angles of the support bracket 9 (e.g., folded state, small-angle open state, large-angle open state). In the folded state, the support bracket 9 is rotated to be parallel (overlapping) with the side surface of the second housing 1. In the small-angle open state, the support bracket 9 is rotated to open at a smaller angle relative to the second housing 1. In the large-angle open state, the support bracket 9 is rotated to open at a larger angle relative to the second housing 1, with this opening angle being larger than that in the small-angle open state. The support bracket 9 is radially provided with a mounting slot 9a along its rotation axis for installing the damping member 9b. Two ends of the damping member 9b respectively abut against the bottom of the mounting slot 9a and the extension portion 18. Thus, when the support bracket 9 rotates, the head of the damping member 9b is compressed by the extension portion 18, causing compressive deformation and increasing the friction between it and the extension portion 18, thereby enhancing the rotational damping. When the damping member 9b rotates to one recessed portion 19, the compression from the extension portion 18 on the damping member 9b disappears, allowing the compressive deformation of the damping member 9b to recover. The head 9b1 of the damping member 9b extends into the recessed portion 19, generating frictional vibration and a sense of engagement, improving the tactile feel during rotation of the support bracket 9. When the food cutting device 1000 is in use, the support bracket 9 is in the small-angle or large-angle open state with the head 9b1 of the damping member 9b extending into another recessed portion 19. The recessed portion 19 restricts the rotation of the support bracket 9, requiring a larger force applied to the support bracket 9 to cause it to rotate, thereby preventing the support bracket 9 from folding inward due to vibration during cutting operation.

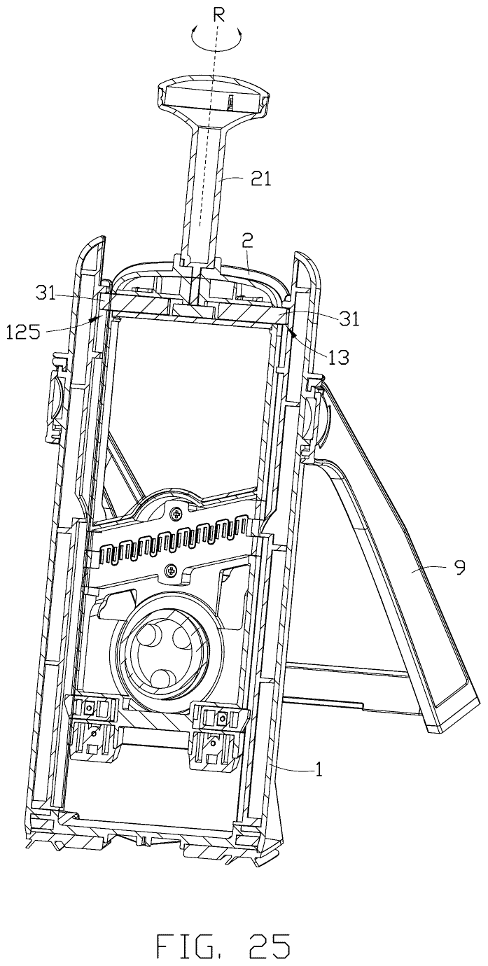

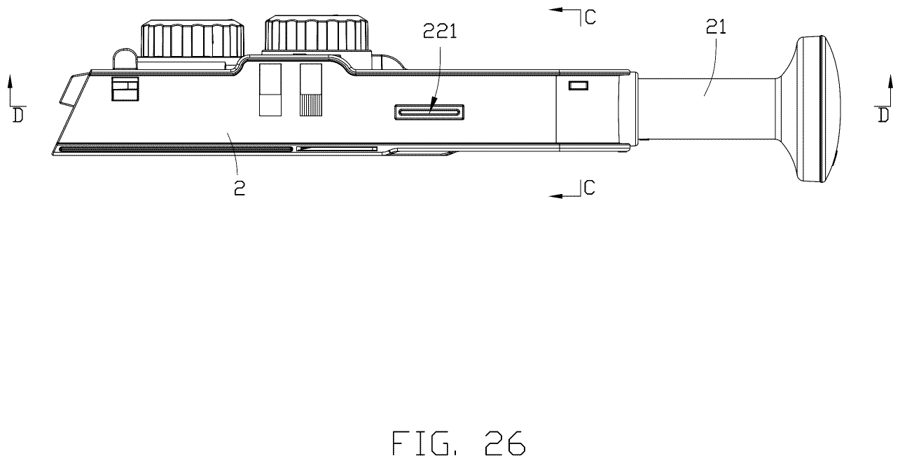

In some embodiments, as shown in FIGS. 25 and 26, the top end of the first housing 2 is provided with a handle 21, such as a push rod, for convenient handheld operation. Pushing the handle 21 causes the first housing 2 to slide downward relative to the second housing 1 to cut food. A spring (not shown in the figures) is further provided inside the second housing 1, resists against the first housing 2 to constantly bias the first housing 2 to slide upward relative to the second housing 1. With the cooperation of the handle 21 and the spring, the first housing 2 performs up-and-down reciprocation along the second housing 1.

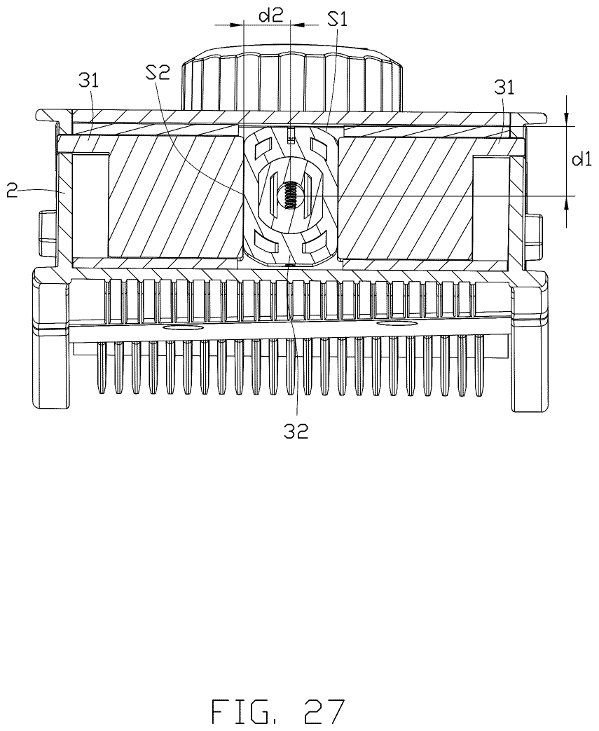

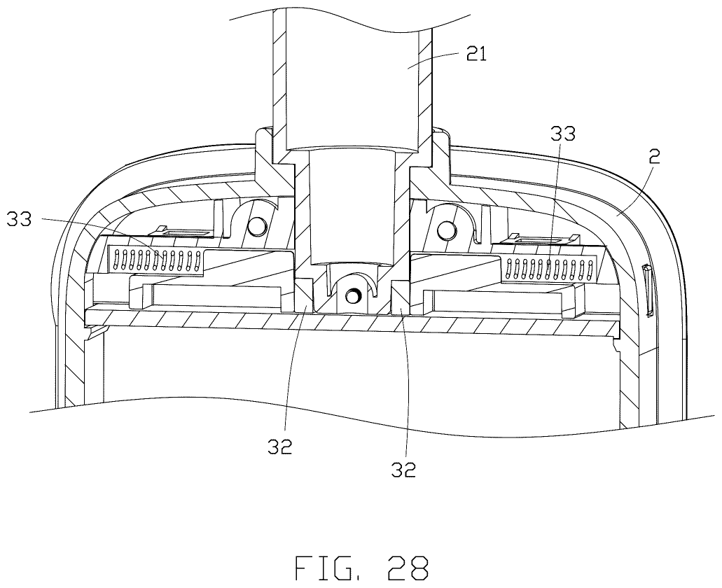

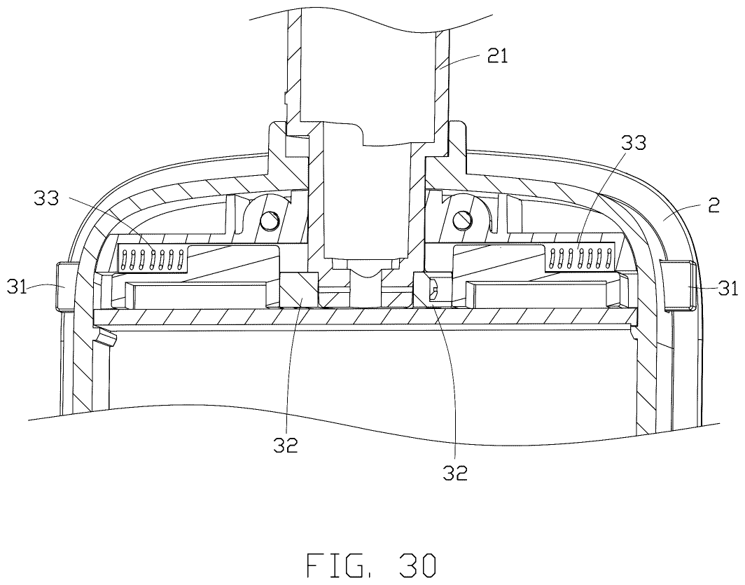

In some embodiments, to facilitate locking the first housing 2 onto the second housing 1, as shown in FIGS. 27 and 30, the handle 21 is rotatable relative to the first housing 2 about its own axis R. A locking block 31 is disposed inside the first housing 2. The side wall 12 of the second housing 1 has a locking groove 125 on its inner side that cooperates with the locking block 31. Rotation of the handle 21 may drive the locking block 31 to move laterally. This configuration allows locking the first housing 2 by rotating the handle 21 while pushing it, completing the locking action on a single component for convenient operation. When the food cutting device 1000 is idle, pushing the handle 21 downward causes the first housing 2 to move downward relative to the second housing 1. At this time, rotating the handle 21 causes the locking block 31 to extend laterally out of the first housing 2 and engaged into the locking groove 125 to lock the first housing 2, preventing it from sliding upward, thereby reducing the volume of the food cutting device 1000. For consumers, this structure allows convenient storage when the food cutting device 1000 is idle. For manufacturers, it is able to reduce the volume of the packaging box and lower costs. When the food cutting device 1000 needs to be used, rotating the handle 21 in the reverse direction causes the locking block 31 to retract, releasing the lock between the first housing 2 and the second housing 1. At this time, the first housing 2 is able to move reciprocally (upwardly and downwardly) relative to the second housing 1 to cut food.

In some embodiments, a transmission block 32 is disposed inside the cutting frame 22 and is connected to the bottom of the handle 21. This transmission block 32 is in contact with the locking block 31.

Specifically, the axis R passes through the geometric center of the transmission block 32. The transmission block 32 has a first length along its long side and a second length along its short side, the first length being greater than the second length. In other words, the transmission block 32 has first side edges S1 disposed on two sides along the short side direction and second side edges S2 disposed on two sides along the long side direction. The first side edge S1 and the second side edge S2 are adjacently connected. The second side edge S2 extending along the long side direction is longer than the first side edge S1 extending along the short side direction. There is a relationship between the distance d1 from the first side edge S1 to the axis R of the handle 21 and the distance d2 from the second side edge S2 to the axis R of the handle 21: d1>d2.

The transmission block 32 is rotatable with the handle 21 and selectively cause the first side edge S1 or the second side edge S2 to act on the locking block 31, thereby changing the distance between the locking block 31 and the axis R of the handle 21 for inward and outward movement. Adjacent first and second side edges S1, S2 are connected by an arc transition to avoid vibration affecting the tactile feel during rotation of the push rod. An elastic member is further provided inside the first housing 2. In this embodiment, the elastic member is a compression spring 33. Two ends of the compression spring 33 respectively abut against an inner wall of the first housing 2 and the locking block 31, thereby resists against the locking block 31 and constantly biasing the locking block 31 to retract. In the state where the first housing 2 is locked onto the second housing 1, rotating the handle 21 drives the transmission block 32 to rotate, causing the first side edge S1 to act on the locking block 31. Since the distance d1 from the first side edge S1 to the axis R of the handle 21 is larger, it may push the locking block 31 to extend laterally against the elastic force of the elastic member and extend into the locking groove 125, locking the first housing 2 onto the second housing 1. In the state where the first housing 2 is unlocked from the second housing 1, rotating the handle 21 in the reverse direction drives the transmission block 32 to rotate, causing the second side edge S2 to act on the locking block 31. Since the distance d2 from the second side edge S2 to the axis R of the handle 21 is smaller, the transmission block 32 loses the pushing force, and the locking block 31 retracts under the action of the compression spring 33. The lock between the locking block 31 and the locking groove 125 is released, and the first housing 2 may move up and down reciprocally relative to the second housing 1.

In some embodiments, as shown in FIGS. 1 and 19, the front wall 11 of the second housing 1 is further provided with a cylinder lock block 16. The cylinder lock block 16 is used to limit a material placing cylinder 17 disposed at the feeding port 120. As an example, the cylinder lock block 16 is connected to a lock button 161. The lock button 161 is movable along the Y-direction. Driven by the lock button 161, the cylinder lock block 16 moves along the Y-direction, thereby limiting the material placing cylinder 17 inserted into the feeding port 120 (e.g., abutting against the material placing cylinder 17). Further, the cylinder lock block 16 and the lock button 161 are disposed above the feeding port 120. An installation through-hole 110 (see FIG. 18) may be formed through the front wall 11 of the second housing 1, and the cylinder lock block 16 and the lock button 161 are disposed in the installation through-hole 110. In this embodiment, the lock button 161 is exposed on the outer surface of the front wall 11, and the cylinder lock block 16 is located on the inner side of the front wall 11. The lock button 161 is toggled to drive the cylinder lock block 16 to move along the Y-direction. The feeding port 120 is for installing the material placing cylinder 17 and allowing food ingredients to enter the cutting area from the feeding port 120 for cutting. The ejection component installation hole 130 is for directly installing the ejection component 5 or for installing the connector 115.

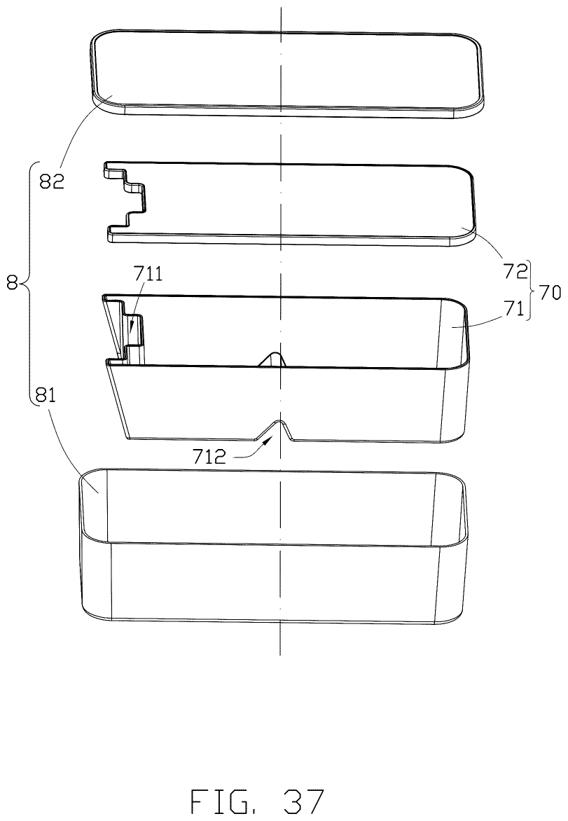

In some embodiments, as shown in FIG. 37, the receiving box 70 comprises, for example, a first box body 71 with an open top and a first cover 72 for covering the open top of the first box body 71. An end of the first box body 71 close to the second housing 1 is provided with an avoidance groove 711 for avoiding interference with the first housing 2. The bottom of the first box body 71 is provided with a clamping groove 712 that allows the support bracket 9 to get stuck inside the clamping groove 712. After receiving the cut food, the receiving box 70 may be covered with the first cover 72, serving as a storage box to store the cut food for later use.

Further, as shown in FIG. 37, the storage box 8 comprises a second box body 81 with an open top and a second cover 82 for covering the open top of the second box body 81. The receiving box 70 is able to be received inside the second box body 81. Both the storage box 8 and the receiving box 70 are used for storing food. The receiving box 70 is able to be received inside the storage box 8 to reduce space occupation. For manufacturers, this may reduce the volume of the packaging box, lowering production and transportation costs.

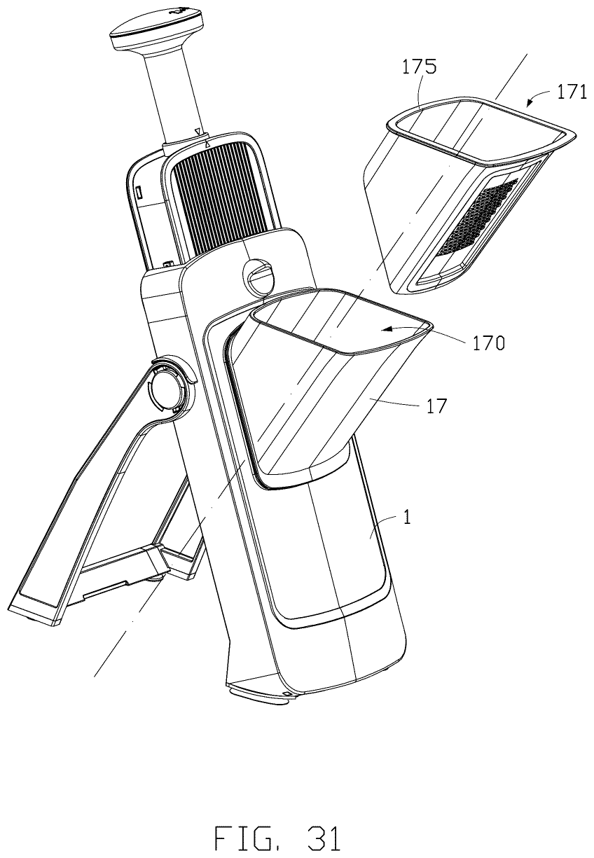

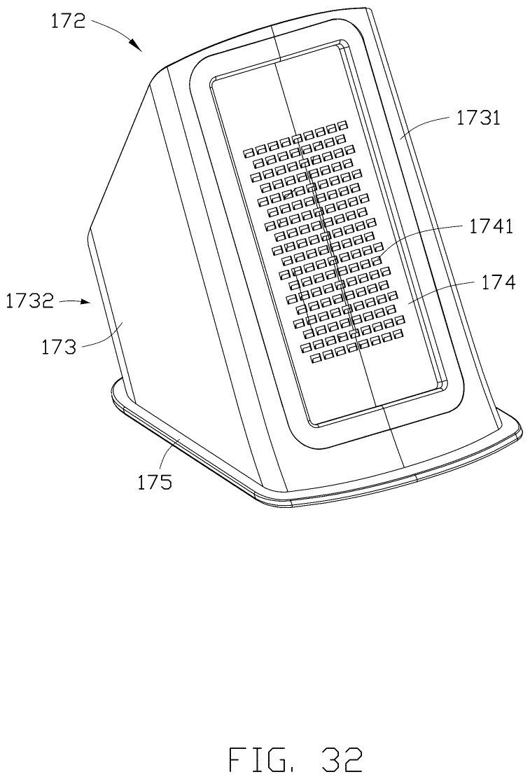

In some embodiments, as shown in FIG. 31, the food cutting device 1000 further comprises a food pushing component 171 received in the material placing cavity 170, wherein the food pushing component 171 is slidably attached to an inner wall of the material placing cylinder 17. The food pushing component 171 is shaped to match the material placing cavity 170 and is slidable within the material placing cavity 170 along the Y-direction. It is used to apply force to the food to be cut, pushing the ingredients toward the cutting component 210 to ensure thorough cutting and prevent ingredients from remaining in the material placing cylinder 17.

As shown in FIGS. 32 to 36, the food pushing component 171 has a bottom wall 172 and a plurality of side walls 173 surrounding the bottom wall 172. An upward-opening recessed cavity 1710 is defined by the bottom wall 172 and the plurality of side walls 173. The recessed cavity 1710 has an opening.

In some embodiments, the plurality of side walls 173 of the food pushing component 171 comprises a first wall 1731 and a second wall 1732 arranged opposite each other. The area of the first wall 1731 is larger than that of the second wall 1732. The first wall 1731 forms an angle with the bottom wall 172.

In some embodiments, the first wall 1731 is provided with a grater blade 174. The grater blade 174 has a plurality of grating holes 1741 extending therethrough. The grating holes 1741 are in communication with the recessed cavity 1710, giving the food pushing component 171 the additional function of grating. The first wall 1731 may be provided with a window 177. The grater blade 174 is embedded in the window 177. At least two protrusions 116 are distributed along the periphery of the window 177 on the first wall 1731 of the food pushing component 171. Correspondingly, the grater blade 174 is provided with assembly holes 176 for the protrusions 116 to pass through. The food pushing component 171 further comprises a pressure ring 14. The pressure ring 14 is formed on the periphery of the grater blade 174 and presses and fixes the grater blade 174 within the window 177, preventing the grater blade 174 from shifting or loosening during the grating process and ensuring the stability of the grating operation. During assembly, the assembly holes 176 of the grater blade 174 are first aligned with the protrusions 116 on the food pushing component 171 and inserted, achieving pre-positioning of the grater blade 174. Then, fixation is completed through the pressing action of the pressure ring 14, providing convenient assembly and firm connection.

In some embodiments, a plurality of convex points 1721 are arranged on the bottom wall 172 of the food pushing component 171. The convex points 1721 protrude away from the side of the recessed cavity 1710, serving both grinding and anti-slip functions: when used as a food pushing component 171, the convex points 1721 is able to increase friction with the ingredients to prevent slipping; when the food pushing component 171 is taken out, the convex points 1721 can be used to grind fruits and vegetables like garlic or wasabi into paste.

In some embodiments, the periphery of the opening of the recessed cavity 1710 of the food pushing component 171 may have an outwardly protruding flange 175. The flange 175 may place on the outer end face of the material placing cylinder, ensuring that when the food pushing component 171 is pushed to the deepest part of the material placing cavity 170, a portion still protrudes from the material placing cylinder for easy removal.

In the description of the embodiments of the present disclosure, it should be noted that in the description of the present disclosure, directional or positional terms such as “inner”, “outer”, “upper”, “lower”, “front”, “rear” are based on the directions or positional relationships shown in the drawings. This is merely for ease of description and does not indicate or imply that the device or component must have a specific orientation, be constructed, or operate in a specific orientation. Therefore, these terms should not be construed as limiting the present disclosure.

In the description of the present disclosure, references to terms such as “this embodiment”, “some embodiments”, etc., mean that the specific features, structures, materials, or characteristics described in connection with that embodiment or example are included in at least one embodiment or example of the present disclosure. In this specification, schematic references to the above terms do not necessarily refer to the same embodiment or example. Furthermore, the specific features, structures, materials, or characteristics described may be combined in any suitable manner in one or more embodiments or examples. Additionally, without contradiction, those skilled in the art can combine and integrate the different embodiments or examples and the features of the different embodiments or examples described in this specification.

Unless stated otherwise, terms such as “first” and “second” are used to arbitrarily distinguish between the elements such terms describe. Thus, these terms are not necessarily intended to indicate temporal or other prioritization of such elements.

The present disclosure is not limited to the above embodiments, and various changes can be made within the scope shown in the claims. Embodiments obtained by appropriately combining the technical solutions disclosed in different embodiments are also included in the technical scope of the present disclosure. Furthermore, new technical features can be formed by combining the technical means disclosed in each embodiment respectively.

What is claimed is:

1. A food cutting device, comprising:
a housing assembly comprising a first housing, a second housing, and an ejection component connected to the second housing for ejecting food residues remaining in the housing assembly; and
a cutting assembly coupled to the first housing and disposed opposite the ejection component; wherein:
the first housing is slidably attached to the second housing;
the ejection component comprises a base portion connected to the second housing, and a plurality of ribs projecting away from the second housing and extending along a height direction of the second housing;
the plurality of ribs is arranged at intervals along a width direction of the second housing; and
each rib includes a top surface, the base portion includes an upper surface, wherein the top surface is higher than the upper surface of the base portion in the height direction.

2. The food cutting device of claim 1, wherein:
a width of each of the plurality of ribs is a; and
a height h is a height difference between the top surface of each rib and the upper surface of the base portion, wherein a and h satisfy:
1.0 mm≤h≤6.0 mm in a case that 1.0 mm≤a≤1.8 mm;
1.0 mm≤h≤8.0 mm in a case that 1.8 mm<a≤3.3 mm.

3. The food cutting device of claim 1, wherein the ejection component is an integrally formed structure;
each rib comprises a tooth portion connected to a side of the base portion away from the second housing and a projecting portion upwardly extending from the tooth portion;
an upper surface of the projecting portion forms the top surface; and
the tooth portion includes an upper surface, the upper surface of the tooth portion is lower than the top surface, and the upper surface of the base portion is connected to the upper surface of the tooth portion.

4. The food cutting device of claim 3, wherein the projecting portion includes an inclined surface adjacent to the base portion; and
the upper surface of the tooth portion is connected to the top surface via the inclined surface, and the inclined surface is inclined away from the base portion toward the top surface.

5. The food cutting device of claim 1, wherein
a connector is configured for connecting the second housing and the ejection component;
the connector comprises a plurality of insertion strips projecting away from the second housing and arranged at intervals along the width direction;
a plurality of insertion slots is formed in a side of the base portion facing the second housing; and
the plurality of insertion slots corresponds one-to-one with the plurality of insertion strips, and each of the plurality of the insertion strips is insertable into a corresponding insertion slot of the plurality of insertion slots.

6. The food cutting device of claim 1, wherein the cutting assembly comprises a cutting component attached to the first housing, the cutting component comprising a first cutting blade and a plurality of second cutting blades;
the first cutting blade is connected to the first housing with a cutting edge of the first cutting blade facing the ribs; and
each of the second cutting blades is connected to the first housing with the cutting edge of the first cutting blade being disposed opposite a back edge of each of the plurality of second cutting blades, with a predetermined gap formed between the cutting edge of the first cutting blade and the back edge of each of the plurality of second cutting blades.

7. The food cutting device of claim 6, wherein in a case that the cutting component moves to a proximal position closest to the ejection component, each second cutting blade is located in a gap between corresponding two adjacent ribs of the plurality of ribs; and
the top surface extends higher than the back edge of each of the plurality of second cutting blades and the cutting edge of the first cutting blade in the height direction, the plurality of ribs is spaced from the first cutting blade, and the upper surface of the base portion is spaced from the first cutting blade.

8. The food cutting device of claim 7, wherein an avoidance groove is formed in a bottom surface of the ejection component between each two adjacent ribs of the plurality of ribs;
the avoidance groove is recessed toward the base portion; and
in the case that the cutting component moves to the proximal position closest to the ejection component, the avoidance groove receives a portion of the cutting edge of one of the plurality of second cutting blades.

9. The food cutting device of claim 6, wherein the first housing comprises a cutting frame and a guide plate;
the cutting frame is configured to mount the cutting component;
the guide plate is connected to the cutting frame and comprises a plurality of guide ribs extending along the height direction and arranged at intervals along the width direction;
a guide sliding groove is formed between each two adjacent guide ribs of the plurality of guide ribs, and a corresponding rib of the plurality of ribs is slidable along the guide sliding groove;
each second cutting blade corresponds to a corresponding guide rib of the plurality of guide ribs; and
each second cutting blade is aligned along a same line in the height direction as the corresponding guide rib.

10. The food cutting device of claim 9, wherein in a case that the cutting component moves to a distal position farthest from the ejection component, the plurality of second cutting blades is moved away from the ejection component, the cutting edge of the first cutting blade faces the plurality of ribs, and at least one rib of the plurality of ribs is received in a corresponding guide sliding groove of the plurality of guide sliding grooves.

11. The food cutting device of claim 9, wherein the cutting assembly further comprises a thickness adjusting member connected to the guide plate and configured to adjust positions of the guide plate relative to the first cutting blade in a thickness direction of the second housing; and
the cutting assembly further comprises a blade adjusting member connected to the plurality of second cutting blades and configured to adjust positions of the plurality of second cutting blades relative to the first cutting blade in the thickness direction.

12. The food cutting device of claim 6, wherein an extension line L1 of the cutting edge of the first cutting blade forms an acute angle relative to the width direction, and the extension line L1 of the first cutting blade is parallel to a connecting line L3; the connecting line L3 is defined by the top surfaces of the plurality of ribs.

13. The food cutting device of claim 1, wherein the second housing comprises a front wall, a first side wall and a second side wall connected to opposite sides of the front wall, a first limiting wall projecting from an end of the first side wall away from the front wall toward the second side wall, and a second limiting wall projecting from an end of the second side wall away from the front wall toward the first side wall;
the first side wall and the second side wall project from the front wall of the second housing and extend along the width direction;
the front wall, the first side wall, the second side wall, the first limiting wall, and the second limiting wall are integrally formed; and
the ejection component is disposed on a surface of the front wall and between the first side wall and the second side wall.

14. The food cutting device of claim 13, wherein the first housing comprises a cutting frame and a handle;
the cutting frame reciprocates in the height direction relative to the second housing by pushing and pulling the handle;
the handle is a push rod connected to a top of the cutting frame;
the push rod is rotatably coupled to the cutting frame, the push rod is rotatable about an axis of the push rod;
the cutting frame accommodates two locking blocks;
two locking grooves are respectively defined at the first side wall and the second side wall of the second housing, and each locking block engages with a corresponding locking groove of the two locking grooves; and
the push rod is further configured to rotate to drive the two locking blocks to extend or retract, such that a part of each locking block extends outward from the cutting frame and engages with the corresponding locking groove to lock the cutting frame relative to the second housing.

15. The food cutting device of claim 14, further comprising a transmission block connected to the push rod; wherein
the two locking blocks abut opposite sides of the transmission block;
one side of each of the two locking blocks abuts the transmission block, and another side of each of the two locking blocks projects outwardly from the first housing; and
the transmission block has a first length at a long side, a second length at a short side, and the first length is greater than the second length.

16. The food cutting device of claim 15, wherein the transmission block includes first side edges disposed on two sides along the short side and second side edges disposed on two sides along the long side; and
the first side edges are adjacently connected to the second side edges, and a first side edge of the first side edges and an adjacent second side edge of the second side edges are connected with a rounded transition.

17. The food cutting device of claim 15, wherein two elastic members are disposed inside the cutting frame; and
each of the two elastic members resists against each of the two locking blocks to keep the two locking blocks abutting against the transmission block.

18. The food cutting device of claim 17, wherein each of the two elastic members is a compression spring; and
one end of the compression spring abuts an inner wall of the cutting frame and another end of the compression spring abuts a corresponding locking block of the two locking blocks.

19. The food cutting device of claim 1, further comprising a support bracket rotatably coupled to an outer side of a side wall of the second housing; wherein
the second housing is formed with two extension portions extending outwardly;
recessed portions are formed in each extension portion of the two extension portion along a rotation path of the support bracket;
the support bracket has a convex point configured for coupling to one of the recessed portions to restrict a rotation of the support bracket.

20. The food cutting device of claim 19, wherein
the support bracket forms a mounting slot configured for receiving a damping member; and
a head of the damping member is configured to extend from the mounting slot serving as the convex point and is extendable into the one of the recessed portions to restrict the rotation of the support bracket;
the rotation of the support bracket is restricted when one end of the damping member abuts the bottom of the mounting slot and another end of the damping member the extends into the one of the recessed portions.

21. The food cutting device of claim 1, further comprising a receiving box and a storage box; wherein
the receiving box is disposed at a rear side of the housing assembly to collect cut food, and the storage box is configured to receive the receiving box therein.

22. The food cutting device of claim 21, wherein the receiving box comprises a first box body with an open top and a first cover for covering the open top of the first box body;
a relief groove configured for avoiding interference with the first housing is formed at an end of the first box body adjacent to the second housing; and
the storage box comprises a second box body comprising an open top and a second cover configured for covering the open top of the second box body.

23. The food cutting device of claim 1, wherein a feeding port is formed in the second housing, and a material placing cylinder is connected to the second housing and opposite to the feeding port;
the material placing cylinder includes a material placing cavity having an open top configured for receiving food to be cut;
the food cutting device further comprises a food pushing component received in the material placing cavity, wherein the food pushing component is slidably attached to an inner wall of the material placing cylinder;
the food pushing component includes a bottom wall and a plurality of side walls connected to and surrounding the bottom wall, the bottom wall and the side walls defining an upwardly open concave cavity; and
a grater blade is disposed on one of the side walls of the food pushing component, the grater blade defines a plurality of grating holes extending through the grater blade, wherein the plurality of grating holes is in communication with the concave cavity.

24. The food cutting device of claim 23, wherein a plurality of protrusions configured for grinding or gripping food is arranged on the bottom wall of the food pushing component, the plurality of protrusions protruding away from the concave cavity.

25. The food cutting device of claim 23, wherein the side walls of the food pushing component comprise a first wall and a second wall arranged opposite each other, an area of the first wall is larger than an area of the second wall, and the grater blade is disposed on the first wall.

26. The food cutting device of claim 13, wherein the front wall, the first side wall, and the first limiting wall cooperatively define a first accommodating cavity, and the front wall, the second side wall, and the second limiting wall cooperatively define a second accommodating cavity;
a slide rail assembly is disposed in each of the first accommodating cavity and the second accommodating cavity, the slide rail assembly defining a slide groove extending along the height direction; and
two sliders protrude from respective two sides of the first housing toward the corresponding slide grooves, and the first housing is slidably attached to the second housing in the height direction as the two sliders move along the slide grooves.

27. A food cutting device, comprising:
a housing assembly comprising a first housing, a second housing, and an ejection component connected to the second housing for ejecting food residues remaining in the housing assembly; and
a cutting assembly coupled to the first housing and disposed opposite the ejection component; wherein:
the first housing is slidably attached to the second housing;
the cutting assembly comprises a first cutting blade and a plurality of second cutting blades, a cutting edge of the first cutting blade is disposed opposite a back edge of each second cutting blade, with a predetermined gap formed between the cutting edge of the first cutting blade and the back edge of each of the plurality of second cutting blades;
the ejection component comprises a main body and a plurality of projecting portions projecting from the main body along the height direction, wherein the plurality of projecting portions is arranged at intervals along the width direction of the second housing; and
in a case that the cutting assembly moves to a proximal position closest to the ejection component, a top end of each of the plurality of projecting portion extends beyond the back edge of each of the plurality of second cutting blades and the cutting edge of the first cutting blade in the height direction, and is spaced apart from the first cutting blade.

28. The food cutting device of claim 27, wherein a width of each projecting portion in the width direction is a; and
a height of each projecting portion in the height direction is h, and a and h satisfy:
1.0 mm≤h≤6.0 mm when 1.0 mm≤a≤1.8 mm;
1.0 mm≤h≤8.0 mm when 1.8 mm<a≤3.3 mm.

29. The food cutting device of claim 27, wherein the ejection component is an integrally formed structure;
the main body comprises a base portion connected to the second housing and a plurality of tooth portions projecting from the base portion away from the second housing; and
the plurality of tooth portions is arranged at intervals along the width direction of the second housing on a side of the base portion, and each of the plurality of tooth portions is connected one-to-one with each projecting portion.

30. The food cutting device of claim 29, wherein a length of each tooth portion in a thickness direction of the second housing is greater than a length of each projecting portion in the thickness direction.

31. The food cutting device of claim 27, wherein in the case that the cutting assembly moves to the proximal position closest to the ejection component, each of the plurality of second cutting blades is located in a gap between each two adjacent projecting portions of the plurality of projecting portions, and the main body is spaced apart from the first cutting blade.
